(19) United States
(12) Patent Application Publication
(10) Pub. No.: US 2025/0089091 A1
(43) Pub. Date: Mar. 13, 2025

(54) METHOD FOR TRANSMITTING AND RECEIVING SIGNALS IN UNLICENSED SPECTRUM AND DEVICE FOR SAME

(71) Applicant: LG ELECTRONICS INC., Seoul (KR)

(72) Inventors: Sechang MYUNG, Seoul (KR); Suckchel YANG, Seoul (KR); Seonwook KIM, Seoul (KR)

(73) Assignee: LG ELECTRONICS INC., Seoul (KR)

(21) Appl. No.: 18/727,177

(22) PCT Filed: Jan. 2, 2023
(86) PCT No.: PCT/KR2023/000003

§ 371 Date: Jul. 8, 2024

(30) Foreign Application Priority Data
Jan. 7, 2022 (KR) 10-2022-0002990

(51) Int. Cl. H04W 74/0816; H04B 7/06; H04L 5/00; H04W 56/00

(52) U.S. Cl. CPC H04W 74/0816; H04B 7/0626; H04B 7/06968; H04L 5/0051; H04W 56/0015

(57) ABSTRACT

Disclosed is a method for a terminal to perform uplink (UL) transmission in a wireless communication system. In particular, the method comprises the steps in which a base station: receives information related to a sensing beam used for initiating channel occupancy time (COT); determines, on the basis of a quasi co-located (QCL) relationship between the sensing beam and the UL transmission, whether COT sharing is available; on the basis that the COT sharing is not available, senses a channel corresponding to the UL transmission on the basis of a type 1 channel access procedure (CAP) and performs the UL transmission on the basis of the channel being sensed as IDLE; and on the basis that the COT sharing is available, senses the channel on the basis of a type 2 CAP and performs the UL transmission within the COT on the basis of the channel being sensed as IDLE.

### CROSS-REFERENCE TO RELATED APPLICATION(S)

This application is the National Stage filing under 35 U.S.C. 371 of International Application No. PCT/KR2023/000003, filed on Jan. 2, 2023, which claims the benefit of earlier filing date and right of priority to Korean Application No. 10-2022-0002990, filed on Jan. 7, 2022, the contents of which are all incorporated by reference herein in their entirety.

The disclosure relates to a method and apparatus for transmitting and receiving a signal in an unlicensed band, and more particularly, to a method and apparatus for determining whether channel occupancy time (COT) sharing is available based on information about a beam that a receiving end has used to acquire a COT, and transmitting a channel accordingly by a transmitting end.

### BACKGROUND

As more and more communication devices demand larger communication traffic along with the current trends, a future-generation 5th generation (5G) system is required to provide an enhanced wireless broadband communication, compared to the legacy LTE system. In the future-generation 5G system, communication scenarios are divided into enhanced mobile broadband (eMBB), ultra-reliability and low-latency communication (URLLC), massive machine-type communication (mMTC), and so on.

Herein, eMBB is a future-generation mobile communication scenario characterized by high spectral efficiency, high user experienced data rate, and high peak data rate, URLLC is a future-generation mobile communication scenario characterized by ultra-high reliability, ultra-low latency, and ultra-high availability (e.g., vehicle to everything (V2X), emergency service, and remote control), and mMTC is a future-generation mobile communication scenario characterized by low cost, low energy, short packet, and massive connectivity (e.g., Internet of things (IoT)).

### SUMMARY

The disclosure is intended to provide a method and apparatus for transmitting and receiving a signal in an unlicensed band.

It will be appreciated by persons skilled in the art that the objects that could be achieved with the disclosure are not limited to what has been particularly described hereinabove and the above and other objects that the disclosure could achieve will be more clearly understood from the following detailed description.

A method of performing an uplink (UL) transmission by a user equipment (UE) in a wireless communication system according to an embodiment of the disclosure includes receiving information related to a sensing beam used by a base station (BS) to initiate a channel occupancy time (COT), determining whether COT sharing of the COT is available based on a quasi co-location (QCL) relationship between the sensing beam and the UL transmission, based on the COT sharing being not available, sensing a channel corresponding to the UL transmission based on a Type 1 channel access procedure (CAP), and based on the channel being sensed as idle, performing the UL transmission, and based on the COT sharing being available, sensing the channel based on a Type 2 CAP, and based on the channel being sensed as idle, performing the UL transmission within the COT.

It may be determined that the COT sharing is available, based on a reference signal (RS) related to the sensing beam is in the QCL relationship with an RS related to the UL transmission.

Further, the information related to the sensing beam may include at least one of a synchronization signal block (SSB) index, a channel state information-reference signal (CSI-RS) index, or a sounding resource indicator (SRI).

Further, the information related to the sensing beam may be included in a group common-physical downlink control channel (GC-PDCCH).

Further, the Type 1 CAP may be performed based on backoff, and the Type 2 CAP may be performed without backoff.

Further, the method may further include receiving information indicating to perform the Type 1 CAP before the UL transmission. Based on the COT sharing being not available, the Type 1 CAP may be performed based on the information indicating to perform the Type 1 CAP, and based on the COT sharing being available, the information indicating to perform the Type 1 CAP may be ignored, and the Type 2 CAP may be performed.

Further, it may be determined whether the COT sharing is available by further considering that time resources and frequency resources of the UL transmission are included in time resources and frequency resources of a downlink (DL) transmission performed in the COT.

A UE for performing a UL transmission in a wireless communication system according to the disclosure includes at least one transceiver, at least one processor, and at least one memory operably coupled to the at least one processor, and storing instructions which when executed, cause the at least one processor to perform operations. The operations include receiving information related to a sensing beam used by a BS to initiate a COT, through the at least one transceiver, determining whether COT sharing of the COT is available based on a QCL relationship between the sensing beam and the UL transmission, based on the COT sharing being not available, sensing a channel corresponding to the UL transmission based on a Type 1 CAP, and based on the channel being sensed as idle, performing the UL transmission through the at least one transceiver, and based on the COT sharing being available, sensing the channel based on a Type 2 CAP, and based on the channel being sensed as idle, performing the UL transmission within the COT through the at least one transceiver.

It may be determined that the COT sharing is available, based on an RS related to the sensing beam is in the QCL relationship with an RS related to the UL transmission.

Further, the information related to the sensing beam may include at least one of an SSB index, a CSI-RS index, or an SRI.

Further, the information related to the sensing beam may be included in a GC-PDCCH.

Further, the Type 1 CAP may be performed based on backoff, and the Type 2 CAP may be performed without backoff.

Further, the operations may further include receiving information indicating to perform the Type 1 CAP before the UL transmission, through the at least one transceiver. Based on the COT sharing being not available, the Type 1 CAP may be performed based on the information indicating to perform the Type 1 CAP, and based on the COT sharing being available, the information indicating to perform the Type 1 CAP may be ignored, and the Type 2 CAP may be performed.

Further, it may be determined whether the COT sharing is available by further considering that time resources and frequency resources of the UL transmission are included in time resources and frequency resources of a downlink (DL) transmission performed in the COT.

A BS for performing a DL transmission in a wireless communication system according to the disclosure includes at least one transceiver, at least one processor, and at least one memory operably coupled to the at least one processor, and storing instructions which when executed, cause the at least one processor to perform operations. The operations include receiving information related to a sensing beam used by a UE to initiate a COT, through the at least one transceiver, determining whether COT sharing of the COT is available based on a QCL relationship between the sensing beam and the DL transmission, based on the COT sharing being not available, sensing a channel corresponding to the DL transmission based on a Type 1 CAP, and based on the channel being sensed as idle, performing the DL transmission through the at least one transceiver, and based on the COT sharing being available, sensing the channel based on a Type 2 CAP, and based on the channel being sensed as idle, performing the DL transmission within the COT through the at least one transceiver.

A method of performing a DL transmission by a BS in a wireless communication system according to an embodiment of the disclosure includes receiving information related to a sensing beam used by a UE to initiate a COT, determining whether COT sharing of the COT is available based on a QCL relationship between the sensing beam and the DL transmission, based on the COT sharing being not available, sensing a channel corresponding to the DL transmission based on a Type 1 CAP, and based on the channel being sensed as idle, performing the DL transmission, and based on the COT sharing being available, sensing the channel based on a Type 2 CAP, and based on the channel being sensed as idle, performing the DL transmission within the COT.

An apparatus for performing a UL transmission in a wireless communication system according to the disclosure includes at least one processor, and at least one memory operably coupled to the at least one processor, and storing instructions which when executed, cause the at least one processor to perform operations. The operations include receiving information related to a sensing beam used by a BS to initiate a COT, determining whether COT sharing of the COT is available based on a QCL relationship between the sensing beam and the UL transmission, based on the COT sharing being not available, sensing a channel corresponding to the UL transmission based on a Type 1 CAP, and based on the channel being sensed as idle, performing the UL transmission, and based on the COT sharing being available, sensing the channel based on a Type 2 CAP, and based on the channel being sensed as idle, performing the UL transmission within the COT.

A computer-readable storage medium according to the disclosure stores at least one computer program which causes at least one processor to perform operations. The operations include receiving information related to a sensing beam used by a BS to initiate a COT, determining whether COT sharing of the COT is available based on a QCL relationship between the sensing beam and the UL transmission, based on the COT sharing being not available, sensing a channel corresponding to the UL transmission based on a Type 1 CAP, and based on the channel being sensed as idle, performing the UL transmission, and based on the COT sharing being available, sensing the channel based on a Type 2 CAP, and based on the channel being sensed as idle, performing the UL transmission within the COT.

According to the disclosure, even though channel occupancy time (COT) sharing is indicated as available, it may be determined whether COT sharing is available by considering a relationship between a sensing beam used to actually acquire a COT and a beam to be used for a channel transmission, and an inclusion relationship between time and frequency resources of a signal transmitted in the COT and time and frequency resources of a signal to be transmitted by sharing the COT. Therefore, COT sharing may be performed without affecting other signals.

Further, COT sharing and an operation based on the COT sharing are allowed to be performed only in a beam direction and area covered by a sensing beam used in a listen before talk (LBT) procedure to acquire a COT, thereby reducing the probability of channel transmission failure and enabling a stable channel transmission.

It will be appreciated by persons skilled in the art that the effects achievable with the disclosure are not limited to what has been particularly described hereinabove and other advantages of the disclosure will be more clearly understood from the following detailed description taken in conjunction with the accompanying drawings.

### BRIEF DESCRIPTION OF THE DRAWINGS

FIG. 1 is a diagram illustrating an exemplary uplink (UL) transmission operation of a user equipment (UE).

FIG. 2 is a diagram illustrating a wireless communication system supporting an unlicensed band, which is applicable to the disclosure.

FIG. 3 is a diagram illustrating an exemplary method of occupying resources in an unlicensed band, which is applicable to the disclosure.

FIG. 4 is a diagram illustrating an exemplary channel access procedure of a UE for a UL and/or downlink (DL) signal transmission in an unlicensed band, which is applicable to the disclosure.

FIG. 5 is a diagram illustrating a plurality of listen before talk-subbands (LBT-SBs) applicable to the disclosure.

FIG. 6 is a diagram illustrating analog beamforming in a new radio access technology (NR) system.

FIGS. 7 to 11 are diagrams illustrating beam management in the NR system.

FIGS. 12 and 13 are diagrams illustrating a sounding reference signal (SRS) applicable to the disclosure.

FIG. 14 is a diagram illustrating DCI format 2_0.

FIG. 15 is a diagram illustrating beam-based LBT and beam group-based LBT according to an embodiment of the disclosure.

FIG. 16 is a diagram illustrating a problem involved in beam-based LBT according to an embodiment of the disclosure.

FIGS. 17 to 19 are diagrams illustrating an overall process of operating a UE and a base station (BS) according to an embodiment of the disclosure.

FIG. 20 is a diagram illustrating an exemplary communication system applied to the disclosure.

FIG. 21 is a diagram illustrating exemplary wireless devices applicable to the disclosure.

FIG. 22 is a diagram illustrating an exemplary vehicle or autonomous driving vehicle applicable to the disclosure.

### DETAILED DESCRIPTION

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3rd generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

While the following description is given in the context of a 3GPP communication system (e.g., NR) for clarity, the technical spirit of the disclosure is not limited to the 3GPP communication system. For the background art, terms, and abbreviations used in the disclosure, refer to the technical specifications published before the disclosure (e.g., 38.211, 38.212, 38.213, 38.214, 38.300, 38.331, and so on).

5G communication involving a new radio access technology (NR) system will be described below.

Three key requirement areas of 5G are (1) enhanced mobile broadband (eMBB), (2) massive machine type communication (mMTC), and (3) ultra-reliable and low latency communications (URLLC).

Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is AR for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases in a 5G communication system including the NR system will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup may be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G.

Finally, logistics and freight tracking are important use cases for mobile communications that enable the tracking of inventory and packages wherever they are by using location-based information systems. The logistics and freight tracking use cases typically require lower data rates but need wide coverage and reliable location information.

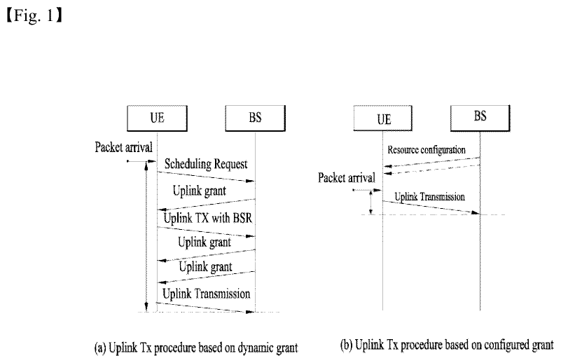

FIG. 1 illustrates an exemplary uplink (UL) transmission operation of a user equipment (UE). The UE may transmit a packet to be transmitted, based on a dynamic grant (FIG. 1(a)) or based on a preconfigured grant (FIG. 1(b)).

For UL, a base station (BS) may dynamically allocate resources for a UL transmission to the UE through PDCCH(s) (including DCI format 0_0 or DCI format 01). Additionally, the BS may allocate UL resources for an initial HARQ transmission to the UE based on a configured grant method (similar to SPS). However, UL resources for a retransmission are explicitly allocated through PDCCH(s). In this way, an operation of preconfiguring UL resources without a dynamic grant (e.g., a UL grant in scheduling DCI) by the BS is called a ‘configured grant’. Two types of configured grants are defined as follows.

Type 1: a UL grant with a predetermined periodicity is provided by higher-layer signaling (without L1 signaling).

Type 2: the periodicity of a UL grant is configured by higher-layer signaling, and activation/deactivation of the configured grant (CG) is signaled by a PDCCH, to provide the UL grant.

Resources for CGs may be shared between a plurality of UEs. A UL signal transmission based on a CG from each UE may be identified by time/frequency resources and a reference signal (RS) parameter (e.g., a different cyclic shift or the like). Therefore, when the UE fails in transmitting a UL signal due to signal collision, the BS may identify the UE and explicitly transmit a retransmission grant for a corresponding transport block (TB) to the UE.

K repeated transmissions including an initial transmission are supported for the same TB by a CG. A HARQ process ID for the UL signal which is repeatedly transmitted K times is determined equally based on resources for the initial transmission. The redundancy versions of a TB, which is repeatedly transmitted K times, have one of patterns {0,2,3,1}, {0,3,0,3}, and {0,0,0,0}.

The UE performs repeated transmissions until one of the following conditions is satisfied:
A UL grant for the same TB is successfully received;
The repetition number of the TB reaches K; and
The ending time of a period P is reached.

Similarly to licensed-assisted access (LAA) in the legacy 3GPP LTE system, use of an unlicensed band for cellular communication is also under consideration in a 3GPP NR system. Unlike LAA, a stand-along (SA) operation is aimed in an NR cell of an unlicensed band (hereinafter, referred to as NR unlicensed cell (UCell)). For example, PUCCH, PUSCH, and PRACH transmissions may be supported in the NR UCell.

On LAA UL, with the introduction of an asynchronous HARQ procedure, there is no additional channel such as a physical HARQ indicator channel (PHICH) for indicating HARQ-ACK information for a PUSCH to the UE. Therefore, accurate HARQ-ACK information may not be used to adjust a contention window (CW) size in a UL listen before talk (LBT) procedure. In the UL LBT procedure, when a UL grant is received in the n-th subframe, the first subframe of the most recent UL transmission burst prior to the (n−3)-th subframe has been configured as a reference subframe, and the CW size has been adjusted based on a new data indicator (NDI) for a HARQ process ID corresponding to the reference subframe. That is, when the BS toggles NDIs per one or more transport blocks (TBs) or instructs that one or more TBs be retransmitted, a method has been introduced of increasing the CW size to the next largest CW size of a currently applied CW size in a set for pre-agreed CW sizes under the assumption that transmission of a PUSCH has failed in the reference subframe due to collision with other signals or initializing the CW size to a minimum value (e.g., CWmin) under the assumption that the PUSCH in the reference subframe has been successfully transmitted without any collision with other signals.

In an NR system to which various Embodiments of the disclosure are applicable, up to 400 MHz per component carrier (CC) may be allocated/supported. When a UE operating in such a wideband CC always operates with a radio frequency (RF) module turned on for the entire CC, battery consumption of the UE may increase.

Alternatively, considering various use cases (e.g., eMBB, URLLC, mMTC, and so on) operating within a single wideband CC, a different numerology (e.g., SCS) may be supported for each frequency band within the CC.

Alternatively, each UE may have a different maximum bandwidth capability.

In this regard, the BS may indicate to the UE to operate only in a partial bandwidth instead of the total bandwidth of the wideband CC. The partial bandwidth may be defined as a bandwidth part (BWP).

A BWP may be a subset of contiguous RBs on the frequency axis. One BWP may correspond to one numerology (e.g., SCS, CP length, slot/mini-slot duration, and so on).

FIG. 1 illustrates an exemplary wireless communication system supporting an unlicensed band applicable to the disclosure.

In the following description, a cell operating in a licensed band (L-band) is defined as an L-cell, and a carrier of the L-cell is defined as a (DL/UL) LCC. A cell operating in an unlicensed band (U-band) is defined as a U-cell, and a carrier of the U-cell is defined as a (DL/UL) UCC. The carrier/carrier-frequency of a cell may refer to the operating frequency (e.g., center frequency) of the cell. A cell/carrier (e.g., CC) is commonly called a cell.

When a BS and a UE transmit and receive signals on carrier-aggregated LCC and UCC as illustrated in FIG. 1(a), the LCC and the UCC may be configured as a primary CC (PCC) and a secondary CC (SCC), respectively. The BS and the UE may transmit and receive signals on one UCC or on a plurality of carrier-aggregated UCCs as illustrated in FIG. 1(b). In other words, the BS and UE may transmit and receive signals only on UCC(s) without using any LCC. For an SA operation, PRACH, PUCCH, PUSCH, and SRS transmissions may be supported on a UCell.

Signal transmission and reception operations in an unlicensed band as described in the disclosure may be applied to the afore-mentioned deployment scenarios (unless specified otherwise).

Unless otherwise noted, the definitions below are applicable to the following terminologies used in the disclosure.
Channel: a carrier or a part of a carrier composed of a contiguous set of RBs in which a channel access procedure (CAP) is performed in a shared spectrum.
Channel access procedure (CAP): a procedure of assessing channel availability based on sensing before signal transmission in order to determine whether other communication node(s) are using a channel. A basic sensing unit is a sensing slot with a duration of Tsl=9 us. The BS or the UE senses the slot during a sensing slot duration. When power detected for at least 4 us within the sensing slot duration is less than an energy detection threshold Xthresh, the sensing slot duration Tsl is be considered to be idle. Otherwise, the sensing slot duration Tsl is considered to be busy. CAP may also be called listen before talk (LBT).
Channel occupancy: transmission(s) on channel(s) from the BS/UE after a CAP.
Channel occupancy time (COT): a total time during which the BS/UE and any BS/UE(s) sharing channel occupancy performs transmission(s) on a channel after a CAP. Regarding COT determination, if a transmission gap is less than or equal to 25 us, the gap duration may be counted in a COT.

The COT may be shared for transmission between the BS and corresponding UE(s).

Specifically, sharing a UE-initiated COT with the BS may mean an operation in which the UE assigns a part of occupied channels through random backoff counter-based LBT (e.g., Category 3 (Cat-3) LBT or Category 4 (Cat-4) LBT) to the BS and the BS performs DL transmission using a remaining COT of the UE, when it is confirmed that a channel is idle by success of LBT after performing LBT without random backoff counter (e.g., Category 1 (Cat-1) LBT or Category 2 (Cat-2) LBT) using a timing gap occurring before DL transmission start from a UL transmission end timing of the UE.

Meanwhile, sharing a gNB-initiated COT with the UE may mean an operation in which the BS assigns a part of occupied channels through random backoff counter-based LBT (e.g., Cat-3 LBT or Cat-4 LBT) to the UE and the UE performs UL transmission using a remaining COT of the BS, when it is confirmed that a channel is idle by success of LBT after performing LBT without random backoff counter (e.g., Cat-1 LBT or Cat-2 LBT) using a timing gap occurring before UL transmission start from a DL transmission end timing of the BS.
DL transmission burst: a set of transmissions without any gap greater than 16 us from the BS. Transmissions from the BS, which are separated by a gap exceeding 16 us are considered as separate DL transmission bursts. The BS may perform transmission(s) after a gap without sensing channel availability within a DL transmission burst.
UL transmission burst: a set of transmissions without any gap greater than 16 us from the UE. Transmissions from the UE, which are separated by a gap exceeding 16 us are considered as separate UL transmission bursts. The UE may perform transmission(s) after a gap without sensing channel availability within a DL transmission burst.
Discovery burst: a DL transmission burst including a set of signal(s) and/or channel(s) confined within a window and associated with a duty cycle. The discovery burst may include transmission(s) initiated by the BS, which includes a PSS, an SSS, and a cell-specific RS (CRS) and further includes a non-zero power CSI-RS. In the NR system, the discover burst includes may include transmission(s) initiated by the BS, which includes at least an SS/PBCH block and further includes a CORESET for a PDCCH scheduling a PDSCH carrying SIB1, the PDSCH carrying SIB1, and/or anon-zero power CSI-RS.

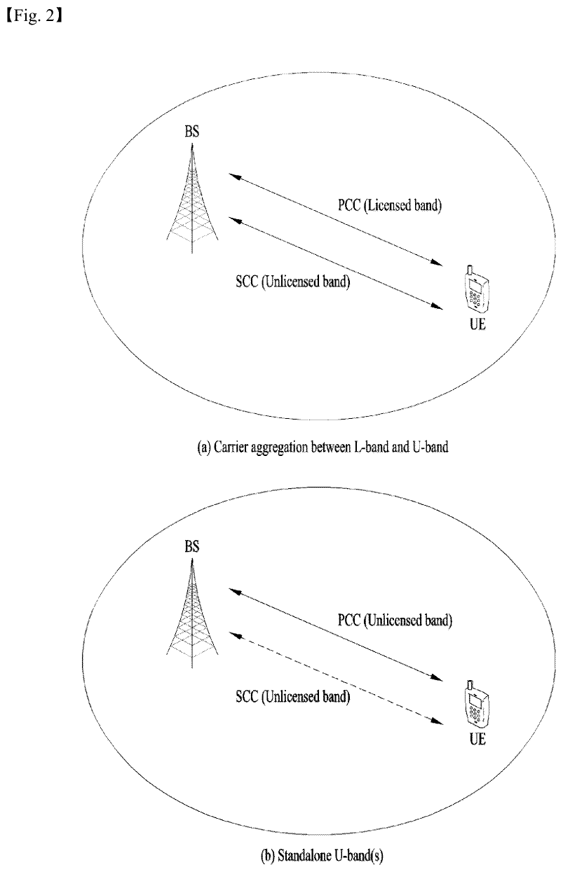

FIG. 2 illustrates an exemplary method of occupying resources in an unlicensed band.

Referring to FIG. 2, a communication node (e.g., a BS or a UE) operating in an unlicensed band should determine whether other communication node(s) is using a channel, before signal transmission. For this purpose, the communication node may perform a CAP to access channel(s) on which transmission(s) is to be performed in the unlicensed band. The CAP may be performed based on sensing. For example, the communication node may determine whether other communication node(s) is transmitting a signal on the channel(s) by carrier sensing (CS) before signal transmission. Determining that other communication node(s) is not transmitting a signal is defined as confirmation of clear channel assessment (CCA). In the presence of a CCA threshold (e.g., Xthresh) which has been predefined or configured by higher-layer (e.g., RRC) signaling, the communication node may determine that the channel is busy, when detecting energy higher than the CCA threshold in the channel. Otherwise, the communication node may determine that the channel is idle. When determining that the channel is idle, the communication node may start to transmit a signal in the unlicensed band. CAP may be replaced with LBT.

Table 1 describes an exemplary CAP supported in NR-U.

TABLE 1

| | Type | Explanation |
|---|---|---|
| DL | Type 1 CAP | CAP with random backoff |
| | | time duration spanned by the sensing slots |
| | | that are sensed to be idle before a |
| | | downlink transmission(s) is random |
| | Type 2 CAP | CAP without random backoff |
| | Type 2A, 2B, | time duration spanned by sensing slots |
| | 2C | that are sensed to be idle before a |
| | | downlink transmission(s) is |
| | | deterministic |
| UL | Type 1 CAP | CAP with random backoff |
| | | time duration spanned by the sensing slots |
| | | that are sensed to be idle before a |
| | | downlink transmission(s) is random |
| | Type 2 CAP | CAP without random backoff |
| | Type 2A, 2B, | time duration spanned by sensing slots |
| | 2C | that are sensed to be idle before a |
| | | downlink transmission(s) is |
| | | deterministic |

In a wireless communication system supporting an unlicensed band, one cell (or carrier (e.g., CC)) or BWP configured for a UE may be a wideband having a larger bandwidth (BW) than in legacy LTE. However, a BW requiring CCA based on an independent LBT operation may be limited according to regulations. Let a subband (SB) in which LBT is individually performed be defined as an LBT-SB. Then, a plurality of LBT-SBs may be included in one wideband cell/BWP. A set of RBs included in an LBT-SB may be configured by higher-layer (e.g., RRC) signaling. Accordingly, one or more LBT-SBs may be included in one cell/BWP based on (i) the BW of the cell/BWP and (ii) RB set allocation information. A plurality of LBT-SBs may be included in the BWP of a cell (or carrier). An LBT-SB may be, for example, a 20-MHz band. The LBT-SB may include a plurality of contiguous (P)RBs in the frequency domain, and thus may be referred to as a (P)RB set.

A UE performs a Type 1 or Type 2 CAP for a UL signal transmission in an unlicensed band. In general, the UE may perform a CAP (e.g., Type 1 or Type 2) configured by a BS, for a UL signal transmission. For example, CAP type indication information may be included in a UL grant (e.g., DCI format 0_0 or DCI format 01) that schedules a PUSCH transmission.

In the Type 1 UL CAP, the length of a time period spanned by sensing slots sensed as idle before transmission(s) is random. The Type 1 UL CAP may be applied to the following transmissions.
PUSCH/SRS transmission(s) scheduled and/or configured by BS
PUCCH transmission(s) scheduled and/or configured by BS
Transmission(s) related to random access procedure (RAP)

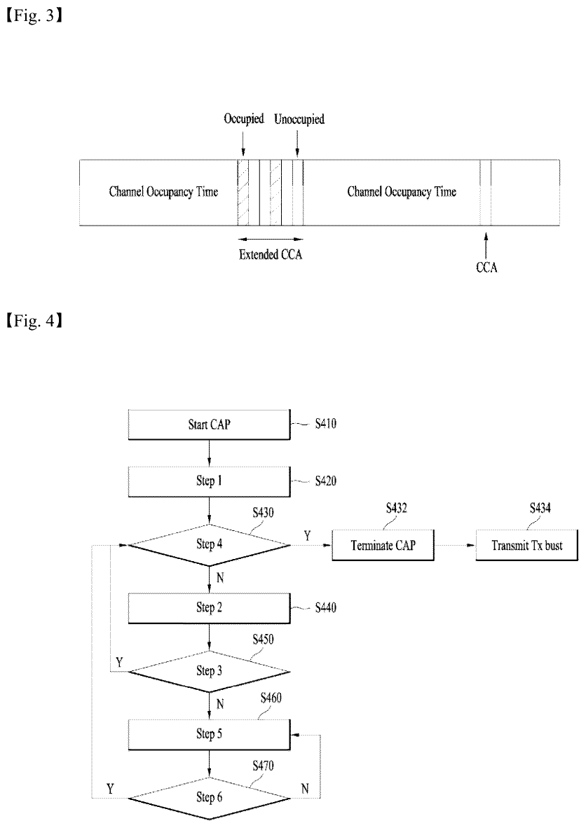

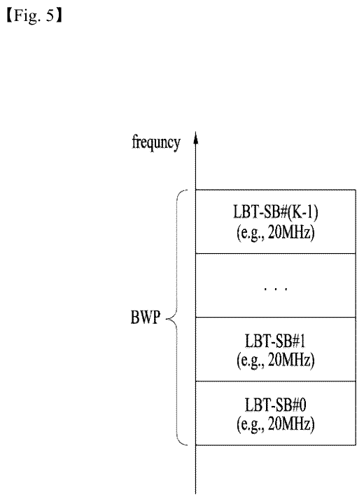

FIG. 3 illustrates Type 1 CAP among channel access procedures of a UE for UL/DL signal transmission in a U-band applicable to the disclosure.

First, UL signal transmission in the U-band will be described with reference to FIG. 3.

The UE may sense whether a channel is idle for a sensing slot duration in a defer duration Td. After a counter N is decremented to 0, the UE may perform a transmission (S334). The counter N is adjusted by sensing the channel for additional slot duration(s) according to the following procedure.

Step 1) Set N=Ninit where Ninit is a random number uniformly distributed between 0 and CWp, and go to step 4 (S320).

Step 2) If N>0 and the UE chooses to decrement the counter, set N=N−1 (S340).

Step 3) Sense the channel for an additional slot duration, and if the additional slot duration is idle (Y), go to step 4. Else (N), go to step 5 (S350).

Step 4) If N=0 (Y) (S330), stop CAP (S332). Else (N), go to step 2.

Step 5) Sense the channel until a busy sensing slot is detected within the additional defer duration Td or all slots of the additional defer duration Td are sensed as idle (S360).

Step 6) If the channel is sensed as idle for all slot durations of the additional defer duration Td (Y), go to step 4. Else (N), go to step 5 (S370).

Table 2 illustrates that mp, a minimum CW, a maximum CW, a maximum channel occupancy time (MCOT), and an allowed CW size applied to a CAP vary according to channel access priority classes.

TABLE 2

| Channel | | | | | | |
|---|---|---|---|---|---|---|
| Access | | | | | | |
| Priority | | | | | | allowed |
| Class (p) | mp | CWmin, p | CWmax, p | Tulmcot, p | | CWp sizes |
| 1 | 2 | 3 | 7 | 2 | ms | {3, 7} |
| 2 | 2 | 7 | 15 | 4 | ms | {7, 15} |
| 3 | 3 | 15 | 1023 | 6 or 10 | ms | {15, 31, 63, 127, |
| | | | | | | 255, 511, 1023} |
| 4 | 7 | 15 | 1023 | 6 or 10 | ms | {15, 31, 63, 127, |
| | | | | | | 255, 511, 1023} |

The defer duration Td includes a duration Tf (16 us) immediately followed by mp consecutive slot durations where each slot duration Tsl is 9 us, and Tf includes a sensing slot duration Tsl at the start of the 16-us duration. CWWmin,p<=CWp<=CWmax,p. CWp is set to CWmin,p, and may be updated before Step 1 based on an explicit/implicit reception response to a previous UL burst (e.g., PUSCH) (CW size update). For example, CWp may be initialized to CWmin,p based on an explicit/implicit reception response to the previous UL burst, may be increased to the next higher allowed value, or may be maintained to be an existing value.

In the Type 2 UL CAP, the length of a time period spanned by sensing slots sensed as idle before transmission(s) is deterministic. Type 2 UL CAPs are classified into Type 2A UL CAP, Type 2B UL CAP, and Type 2C UL CAP. In the Type 2A UL CAP, the UE may transmit a signal immediately after the channel is sensed as idle during at least a sensing duration Tshort_dl (=25 us). Tshort_dl includes a duration Tf (=16 us) and one immediately following sensing slot duration. In the Type 2A UL CAP, Tf includes a sensing slot at the start of the duration. In the Type 2B UL CAP, the UE may transmit a signal immediately after the channel is sensed as idle during a sensing slot duration Tf (=16 us). In the Type 2B UL CAP, Tf includes a sensing slot within the last 9 us of the duration. In the Type 2C UL CAP, the UE does not sense a channel before a transmission.

To allow the UE to transmit UL data in the unlicensed band, the BS should succeed in an LBT operation to transmit a UL grant in the unlicensed band, and the UE should also succeed in an LBT operation to transmit the UL data. That is, only when both of the BS and the UE succeed in their LBT operations, the UE may attempt the UL data transmission. Further, because a delay of at least 4 msec is involved between a UL grant and scheduled UL data in the LTE system, earlier access from another transmission node coexisting in the unlicensed band during the time period may defer the scheduled UL data transmission of the UE. In this context, a method of increasing the efficiency of UL data transmission in an unlicensed band is under discussion.

To support a UL transmission having a relatively high reliability and a relatively low time delay, NR also supports CG type 1 and CG type 2 in which the BS preconfigures time, frequency, and code resources for the UE by higher-layer signaling (e.g., RRC signaling) or both of higher-layer signaling and L1 signaling (e.g., DCI). Without receiving a UL grant from the BS, the UE may perform a UL transmission in resources configured with type 1 or type 2. In type 1, the periodicity of a CG, an offset from SFN=0, time/frequency resource allocation, a repetition number, a DMRS parameter, an MCS/TB size (TBS), a power control parameter, and so on are all configured only by higher-layer signaling such as RRC signaling, without L1 signaling. Type 2 is a scheme of configuring the periodicity of a CG and a power control parameter by higher-layer signaling such as RRC signaling and indicating information about the remaining resources (e.g., the offset of an initial transmission timing, time/frequency resource allocation, a DMRS parameter, and an MCS/TBS) by activation DCI as L1 signaling.

The biggest difference between autonomous uplink (AUL) of LTE LAA and a CG of NR is a HARQ-ACK feedback transmission method for a PUSCH that the UE has transmitted without receiving a UL grant and the presence or absence of UCI transmitted along with the PUSCH. While a HARQ process is determined by an equation of a symbol index, a symbol periodicity, and the number of HARQ processes in the CG of NR, explicit HARQ-ACK feedback information is transmitted in AUL downlink feedback information (AUL-DFI) in LTE LAA. Further, in LTE LAA, UCI including information such as a HARQ ID, an NDI, and an RV is also transmitted in AUL UCI whenever AUL PUSCH transmission is performed. In the case of the CG of NR, the BS identifies the UE by time/frequency resources and DMRS resources used for PUSCH transmission, whereas in the case of LTE LAA, the BS identifies the UE by a UE ID explicitly included in the AUL UCI transmitted together with the PUSCH as well as the DMRS resources.

Now, DL signal transmission in the U-band will be described with reference to FIG. 3.

The BS may perform one of the following U-band access procedures (e.g., channel access procedures (CAPs)) to transmit a DL signal in the U-band.

### (1) Type 1 DL CAP Method

In a Type 1 DL CAP, the length of a time duration spanned by sensing slots that are sensed to be idle before transmission(s) is random. The Type 1 DL CAP may be applied to the following transmissions:
(i) transmission(s) initiated by the BS, including (i) a unicast PDSCH with user plane data, or (ii) a unicast PDSCH with user plane data and a unicast PDCCH scheduling the user plane data; or
transmission(s) initiated by the BS, including (i) only a discovery burst, or (ii) a discovery burst multiplexed with non-unicast information.

Referring to FIG. 4, the BS may first sense whether a channel is idle for a sensing slot duration of a defer duration Td. Next, if a counter N is decremented to 0, transmission may be performed (S434). The counter N is adjusted by sensing the channel for additional slot duration(s) according to the following procedures.
Step 1) Set N=Ninit where Ninit is a random number uniformly distributed between 0 and CWp, and go to step 4 (S420).
Step 2) If N>0 and the BS chooses to decrement the counter, set N=N−1 (S440).
Step 3) Sense the channel for an additional slot duration, and if the additional slot duration is idle (Y), go to step 4. Else (N), go to step 5 (S450).
Step 4) If N=0 (Y), stop a CAP (S432)). Else (N), go to step 2 (S430).
Step 5) Sense the channel until a busy sensing slot is detected within the additional defer duration Td or all slots of the additional defer duration Td are sensed to be idle (S460).
Step 6) If the channel is sensed to be idle for all slot durations of the additional defer duration Td (Y), go to step 4. Else (N), go to step 5 (S370).

Table 3 illustrates that mp, a minimum CW, a maximum CW, an MCOT, and an allowed CW size, which are applied to a CAP, vary according to channel access priority classes.

TABLE 3

| Channel | | | | | | |
|---|---|---|---|---|---|---|
| Access | | | | | | |
| Priority | | | | | | allowed |
| Class (p) | mp | CWmin, p | CWmax, p | Tmcot, p | | CWp sizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, 127, |
| | | | | | | 255, 511, 1023} |

The defer duration Td includes a duration Tf (16 μs) immediately followed by mp consecutive sensing slot durations where each sensing slot duration Tsl is 9 μs, and Tf includes the sensing slot duration Tsl at the start of the 16-μs duration.

CWmin,p<=CWp<=CWmax,p. CWp is set to CWmin,p, and may be updated (CW size update) before Step 1 based on HARQ-ACK feedback (e.g., ratio of ACK signals or NACK signals) for a previous DL burst (e.g., PDSCH). For example, CWp may be initialized to CWmin,p based on HARQ-ACK feedback for the previous DL burst, may be increased to the next highest allowed value, or may be maintained at an existing value.

### (2) Type 2 DL CAP Method

In a Type 2 DL CAP, the length of a time duration spanned by sensing slots sensed to be idle before transmission(s) is deterministic. Type 2 DL CAPs are classified into Type 2A DL CAP, Type 2B DL CAP, and Type 2C DL CAP.

The Type 2A DL CAP may be applied to the following transmissions. In the Type 2A DL CAP, the BS may transmit a signal immediately after a channel is sensed to be idle during at least a sensing duration Tshort_dl=25 μs. Tshort_dl includes a duration Tf (16 μs) and one immediately following sensing slot duration. Tf includes the sensing slot at the start of the duration.
Transmission(s) initiated by the BS, including (i) only a discovery burst, or (ii) a discovery burst multiplexed with non-unicast information, or
Transmission(s) of the BS after a gap of 25 μs from transmission(s) by the UE within shared channel occupancy.

The Type 2B DL CAP is applicable to transmission(s) performed by the BS after a gap of 16 μs from transmission(s) by the UE within shared channel occupancy. In the Type 2B DL CAP, the BS may transmit a signal immediately after a channel is sensed to be idle during Tf=16 μs. Tf includes a sensing slot within the last 9 μs of the duration. The Type 2C DL CAP is applicable to transmission(s) performed by the BS after a maximum of a gap of 16 μs from transmission(s) by the UE within shared channel occupancy. In the Type 2C DL CAP, the BS does not sense a channel before performing transmission.

In a wireless communication system supporting a U-band, one cell (or carrier (e.g., CC)) or BWP configured for the UE may consist of a wideband having a larger BW than in legacy LTE. However, a BW requiring CCA based on an independent LBT operation may be limited according to regulations. If a subband (SB) in which LBT is individually performed is defined as an LBT-SB, a plurality of LBT-SBs may be included in one wideband cell/BWP. A set of RBs constituting an LBT-SB may be configured by higher-layer (e.g., RRC) signaling. Accordingly, one or more LBT-SBs may be included in one cell/BWP based on (i) the BW of the cell/BWP and (ii) RB set allocation information.

FIG. 4 illustrates that a plurality of LBT-SBs is included in a U-band.

Referring to FIG. 4, a plurality of LBT-SBs may be included in the BWP of a cell (or carrier). An LBT-SB may be, for example, a 20-MHz band. The LBT-SB may include a plurality of contiguous (P)RBs in the frequency domain and thus may be referred to as a (P)RB set. Although not illustrated, a guard band (GB) may be included between the LBT-SBs. Therefore, the BWP may be configured in the form of {LBT-SB #0 (RB set #0)+GB #0+LBT-SB #1 (RB set #1+GB #1)+ . . . +LBT-SB #(K−1) (RB set (#K−1))}. For convenience, LBT-SB/RB indexes may be configured/defined to be increased as a frequency band becomes higher starting from a low frequency band.

In the NR system, a massive multiple input multiple output (MIMO) environment with a significantly increased number of transmission/reception (Tx/Rx) antennas may be considered. That is, as the massive MIMO environment is considered, the number of Tx/Rx antennas may increase to tens or hundreds or more. The NR system supports communication in the above 6 GHz band, that is, the millimeter frequency band. However, the millimeter frequency band has the frequency characteristics of vary rapid signal attenuation according to a distance due to the use of too a high frequency band. Therefore, the NR system using a band of 6 GHz or higher uses beamforming to transmit a signal by concentrating energy in a specific direction rather than omni-directionally, in order to compensate for rapid radio wave attenuation. To reduce the complexity of hardware implementation, increase performance using multiple antennas, ensure flexibility in resource allocation, and facilitate beam control on a frequency basis, the massive MIMO environment requires hybrid beamforming that combines analog beamforming and digital beamforming according to a location to which a beamforming weight vector/precoding vector is applied.

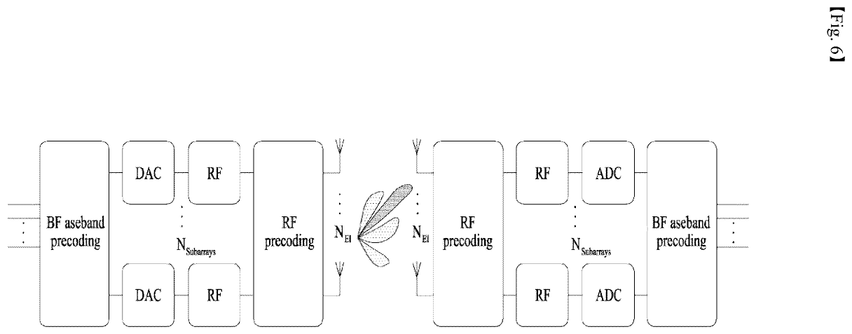

FIG. 6 is an exemplary block diagram illustrating a transmitting end and a receiving end for hybrid beamforming.

As a method to form a narrow beam in the millimeter frequency band, a beamforming technique is mainly considered, in which a BS or a UE transmits the same signal using appropriate phase differences for a large number of antennas, and thus increases energy only in a specific direction. Such beamforming techniques include digital beamforming, which creates a phase difference in a digital baseband signal, analog beamforming, which creates a phase difference using a time delay (i.e., cyclic shift) in a modulated analog signal, and hybrid beamforming using both digital beamforming and analog beam forming. When there is a radio frequency (RF) unit (or transceiver unit (TXRU unit)) for each antenna element, for transmission power control and phase adjustment, independent beamforming may be performed on a frequency resource basis. However, it is not cost effective to install RF units for all of approximately 100 antenna elements. In other words, because the millimeter frequency band requires a large number of antennas to compensate for rapid radio wave attenuation, and digital beamforming requires as many RF components (e.g., digital-to-analog converters (DACs), mixers, power amplifiers, linear amplifiers, and so on) as the number of antennas, the prices of communication devices increase in implementing digital beamforming in the millimeter frequency band. Therefore, when a large number of antennas are required, such as for the millimeter frequency band, the use of analog beamforming or hybrid beamforming is considered. In analog beamforming, multiple antenna elements are mapped to one TXRU and the direction of a beam is adjusted with an analog phase shifter. This analog beamforming may not provide frequency selective beamforming (BF) because only one beam direction may be created across the entire band. Hybrid beamforming is an intermediate form between digital beamforming and analog beamforming, in which there are B RF units fewer than Q antenna elements. In hybrid beamforming, the number of beam directions available for simultaneous transmissions is limited to B or less, in spite of some differences in connections between the B RF units and the Q antenna elements.

### Beam Management (BM)

The BM refers to a series of processes for acquiring and maintaining a set of BS beams (transmission and reception point (TRP) beams) and/or a set of UE beams available for DL and UL transmission/reception. The BM may include the following processes and terminology.
Beam measurement: an operation by which the BS or UE measures the characteristics of a received beamformed signal
Beam determination: an operation by which the BS or UE selects its Tx/Rx beams
Beam sweeping: an operation of covering a spatial domain by using Tx and/or Rx beams for a prescribed time interval according to a predetermined method
Beam report: an operation by which the UE reports information about a signal beamformed based on the beam measurement.

The BM procedure may be divided into (1) a DL BM procedure using an SSB or CSI-RS and (2) a UL BM procedure using an SRS. Further, each BM procedure may include Tx beam sweeping for determining a Tx beam, and Rx beam sweeping for determining an Rx beam.

The DL BM procedure may include (1) transmission of beamformed DL RSs (e.g., CSI-RS or SSB) from the BS and (2) beam reporting from the UE.

A beam report may include preferred DL RS ID(s) and reference signal received power(s) (RSRP(s)) corresponding to the preferred DL RS ID(s). A DL RS ID may be an SSB resource indicator (SSBRI) or a CSI-RS resource indicator (CRI).

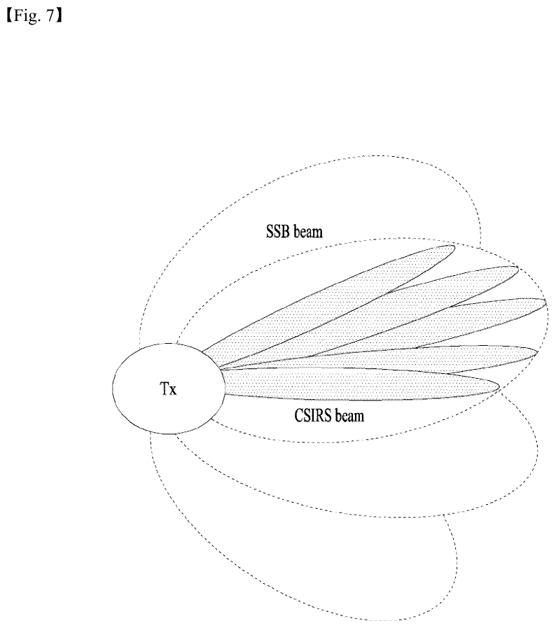

FIG. 7 illustrates an example of beamforming using an SSB and a CSI-RS.

As illustrated in FIG. 7, an SSB beam and a CSI-RS beam may be used for beam measurement. A measurement metric is the RSRP of each resource/block. An SSB is used for coarse beam measurement, and a CSI-RS may be used for fine beam measurement. The SSB may be used for both Tx beam sweeping and Rx beam sweeping. A UE may perform SSB-based Rx beam sweeping by attempting to receive an SSB, while changing an Rx beam for the same SSBRI across multiple SSB bursts. One SS burst includes one or more SSBs, and one SS burst set includes one or more SSB bursts.

### 1. DL BM Using SSB

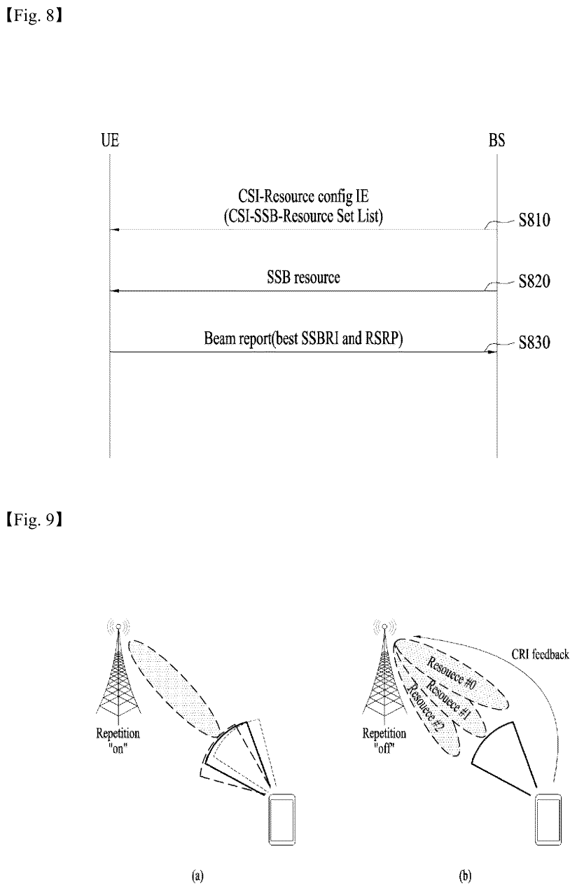

FIG. 8 is a flowchart illustrating an exemplary DL BM process using an SSB.

SSB-based beam reporting is configured during channel state information (CSI)/beam configuration in RRC_CONNECTED.
A UE receives a CSI-ResourceConfig IE including CSI-SSB-ResourceSetList of SSB resources used for beam management from a BS (S810). The RRC parameter, csi-SSB-ResourceSetList indicates a list of SSB resources used for beam management and reporting in one resource set. The SSB resource set may be configured as {SSBx1, SSBx2, SSBx3, SSBx4, . . . }. SSB indexes of 0 to 63 may be defined.
The UE receives signals in the SSB resources based on the CSI-SSB-ResourceSetList from the BS (S820).
When CSI-RS reportConfig related to reporting of an SSBRI and RSRP is configured, the UE reports a best SSBRI and corresponding RSRP to the BS (S830). For example, when reportQuantity is set to ‘ssb-Index-RSRP’ in the CSI-RS reportConfig IE, the UE reports the best SSBRI and the RSRP corresponding to the best SSBRI to the BS.

When a CSI-RS resource is configured in the same OFDM symbol(s) as an SSB, and ‘QCL-TypeD’ is applicable, the UE may assume that the CSI-RS and the SSB are quasi co-located (QCLed) from the perspective of ‘QCL-TypeD’. QCL-TypeD may mean that antenna ports are QCLed from the perspective of spatial Rx parameters. When the UE receives signals from a plurality of DL antenna ports placed in the QCL-TypeD relationship, the UE may apply the same Rx beam.

2. DL BM using CSI-RS

Regarding the usages of the CSI-RS, i) when a parameter, repetition is configured and TRS_info is not configured for a specific CSI-RS resource set, the CSI-RS is used for beam management. ii) When the parameter, repetition is not configured and TRS_info is configured, the CSI-RS is used for a tracking reference signal (TRS). iii) When the parameter, repetition is not configured and TRS_info is not configured, the CSI-RS is used for CSI acquisition.

When (the RRC parameter) repetition is set to ‘ON’, it is related to the Rx beam sweeping process of the UE. In the case where repetition is set to ‘ON’, when the UE receives NZP-CSI-RS-ResourceSet, the UE may assume that signals in at least one CSI-RS resource of the NZP-CSI-RS-ResourceSet are transmitted by the same DL spatial domain filter. That is, at least one CSI-RS resource of the NZP-CSI-RS-ResourceSet is transmitted through the same Tx beam. The signals in the at least one CSI-RS resource of the NZP-CSI-RS-ResourceSet may be transmitted in different OFDM symbols.

On the contrary, when repetition is set to ‘OFF’, it is related to the Tx beam sweeping process of the BS. When repetition is set to ‘OFF’, the UE does not assume that signals in at least one CSI-RS resource of the NZP-CSI-RS-ResourceSet are transmitted by the same DL spatial domain transmission filter. That is, the signals in the at least one CSI-RS resource of the NZP-CSI-RS-ResourceSet are transmitted through different Tx beams. FIG. 12 illustrates another exemplary DL BM process using a CSI-RS.

FIG. 9(a) illustrates an Rx beam determination (or refinement) process of a UE, and FIG. 9(b) illustrates a Tx beam sweeping process of a BS. Further, FIG. 9(a) is for the case where the parameter, repetition is set to “ON” and FIG. 9(b) is for the case where the parameter, repetition is set to “OFF”.

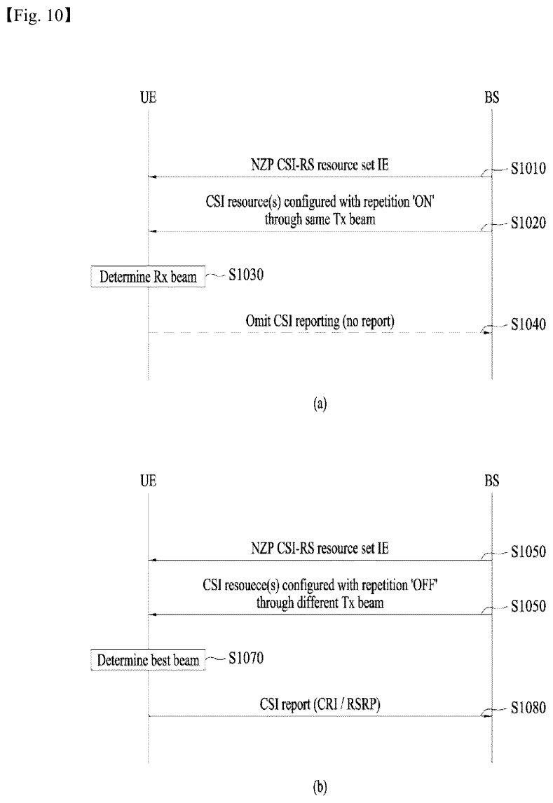

Referring to FIGS. 9(a) and 10(a), the Rx beam determination process of a UE will be described.

FIG. 10(a) is a flowchart illustrating an exemplary Rx beam determination process of a UE.
The UE receives an NZP CSI-RS resource set IE including an RRC parameter ‘repetition’ from the BS by RRC signaling (S1010). The RRC parameter ‘repetition’ is set to ‘ON’.
The UE repeatedly receives signals in resource(s) of a CSI-RS resource set for which the RRC parameter ‘repetition’ is set to ‘ON’ in different OFDM symbols through the same Tx beam (or DL spatial domain transmission filter) of the BS (S1020).
The UE determines its Rx beam (S1030).
The UE skips CSI reporting (S1040). That is, when the RRC parameter ‘repetition’ is set to ‘ON’, the UE may skip CSI reporting.

Referring to FIGS. 9(b) and 10(b), the Tx beam determination process of a BS will be described.

FIG. 10(b) is a flowchart illustrating an exemplary Tx beam determination process of a BS.
The UE receives an NZP CSI-RS resource set IE including an RRC parameter ‘repetition’ from the BS by RRC signaling (S1050). The RRC parameter ‘repetition’ is set to ‘OFF’, which relates to the Tx beam sweeping process of the BS.
The UE receives signals in resources of a CSI-RS resource set for which the RRC parameter ‘repetition’ is set to ‘OFF’ through different Tx beams (DL spatial domain transmission filters) of the BS (S1060).
The UE selects (or determines) a best beam (S1070)
The UE reports the ID (e.g., CRI) and related quality information (e.g., RSRP) of the selected beam to the BS (S1080). That is, when the CSI-RS is transmitted for BM, the UE reports a CRI and RSRP for the CRI to the BS.

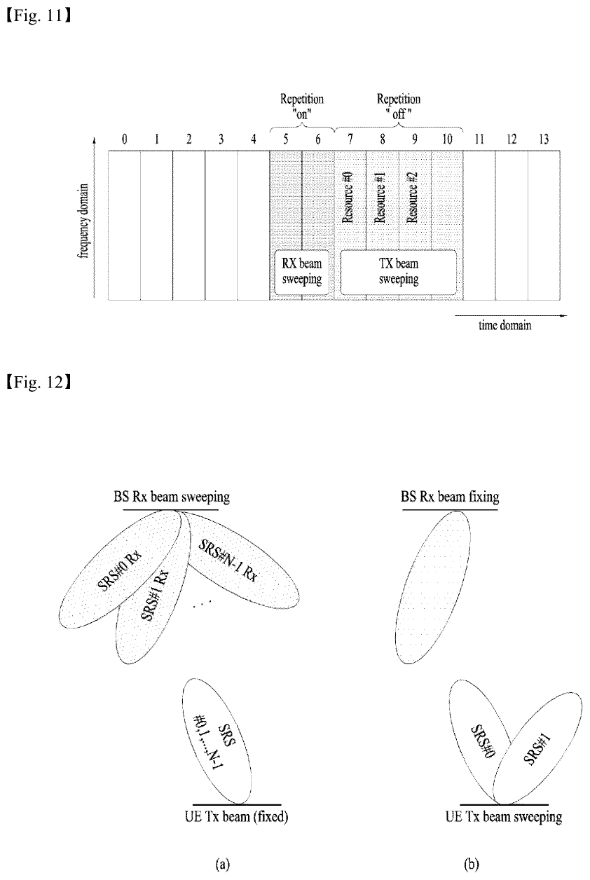

FIG. 11 illustrates an example of resource allocation in the time and frequency domains, which is related to the operation of FIG. 9.

When repetition is set to ‘ON’ for a CSI-RS resource set, a plurality of CSI-RS resources may be used repeatedly by applying the same Tx beam, and when repetition is set to ‘OFF’ for the CSI-RS resource set, different CSI-RS resources may be transmitted through different Tx beams.

### 3. DL BM-Related Beam Indication

The UE may receive at least a list of up to M candidate transmission configuration indication (TCI) states for a quasi co-location (QCL) indication by RRC signaling. M depends on UE capabilities and may be 64.

Each TCI state may be configured with one RS set. Table 4 illustrates an example of a TCI-State IE. The TCI-State IE is associated with a QCL type corresponding to one or two DL RSs.

TABLE 4

| -- ASN1START | |
|---|---|
| -- TAG-TCI-STATE-START | |
| TCI-State ::= | SEQUENCE { |
| tci-StateId | TCI-StateId, |
| qcl-Type1 | QCL-Info, |
| qcl-Type2 | QCL-Info |
| OPTIONAL, -- Need R | |
| ... | |
| } | |
| QCL-Info ::= | SEQUENCE { |
| cell | ServCellIndex |
| OPTIONAL, -- Need R | |
| bwp-Id | BWP-Id |
| OPTIONAL, -- Cond CSI-RS-Indicated | |
| referenceSignal | CHOICE { |
| csi-rs | NZP-CSI-RS- |
| ResourceId, | |
| ssb | SSB- |
| Index | |
| }, | |
| qcl-Type | ENUMERATED |

```
{typeA, typeB, typeC, typeD},
  ...
  }
  -- TAG-TCI-STATE-STOP
  -- ASN1STOP
```

In Table 4, ‘bwp-Id’ indicates a DL BWP in which the RS is located, ‘cell’ indicates a carrier on which the RS is located, and ‘referencesignal’ indicates reference antenna port(s) or reference signal(s) including the reference antenna port(s), which is a QCL source for target antenna port(s). The target antenna port(s) may be CSI-RS, PDCCH DMRS, or PDSCH DMRS.

### 4. Quasi-Co Location (QCL)

The UE may receive a list of up to M TCI-State configurations to decode a PDSCH according to a detected PDCCH carrying DCI intended for the UE and a given cell. M depends on UE capabilities.

As illustrated in Table 4, each TCI-State includes a parameter for establishing a QCL relationship between one or two DL RSs and a DM-RS port of the PDSCH. The QCL relationship is established by an RRC parameter, qcl-Type1 for a first DL RS and an RRC parameter, qcl-Type2 (if configured) for a second DL RS.

The QCL type corresponding to each DL RS is given by a parameter ‘qcl-Type’ in QCL-Info, which may have one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

For example, when a target antenna port is a specific NZP CSI-RS, corresponding NZP CSI-RS antenna ports may be indicated/configured to be QCLed with a specific TRS from the perspective of QCL-Type A and QCLed with a specific SSB from the perspective of QCL-Type D. Upon receipt of the indication/configuration, the UE may receive the NZP CSI-RS using the Doppler and delay values measured in the QCL-TypeA TRS, and apply an Rx beam used for QCL-TypeD SSB reception to receive the NZP CSI-RS.

### UL BM Process

In UL BM, beam reciprocity (or beam correspondence) between a Tx beam and an Rx beam may or may not be established depending on UE implementation. When the Tx beam-Rx beam reciprocity is established at both the BS and the UE, then a UL beam pair may be matched using a DL beam pair. However, when the Tx beam-Rx beam reciprocity is not established at either the BS or the UE, a UL beam pair determination process is required independently of DL beam pair determination.

Further, even when both the BS and UE maintain beam correspondence, the BS may use a UL BM process for DL Tx beam determination without requesting the UE to report a preferred beam.

UL BM may be performed through a beamformed UL sounding reference signal (SRS) transmission, and the applicability of UL BM to an SRS resource set is configured by an RRC parameter, usage. When usage is set to ‘BeamManagement (BM)’, only one SRS resource may be transmitted in each of a plurality of SRS resource sets at a given time instant.

The UE may be configured with one or more SRS resource sets by (an RRC parameter) SRS-ResourceSet (through RRC signaling or the like). For each SRS resource set, the UE may be configured with K>1 SRS resources. K is a natural number, and the maximum value of K is indicated by SRS_capability.

Similarly to DL BM, the UL BM process may be divided into Tx beam sweeping of the UE and Rx beam sweeping of the BS.

FIG. 12 illustrates an exemplary UL BM process using an SRS.

FIG. 12(a) illustrates an Rx beamforming determination process of a BS, and FIG. 12(b) illustrates a Tx beam sweeping process of a UE.

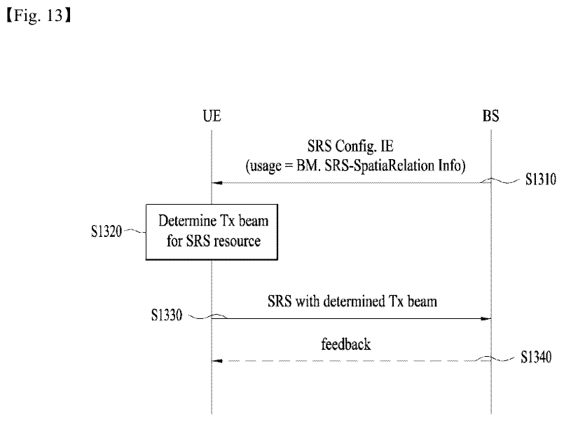

FIG. 13 is a flowchart illustrating an exemplary UL BM process using an SRS.

The UE receives RRC signaling (e.g., an SRS-Config IE) including a parameter (RRC parameter) usage set to ‘beam management’ from the BS (S1310). The SRS-Config IE is used for an SRS transmission configuration. The SRS-Config IE includes a list of SRS-Resources and a list of SRS-ResourceSets. Each SRS-ResourceSet refers to a set of SRS resources.

The UE determines Tx beamforming for an SRS resource to be transmitted, based on SRS-SpatialRelation Info included in the SRS-Config IE (S1320). SRS-SpatialRelation Info is configured for each SRS resource and indicates whether to apply the same beamforming as beamforming used for an SSB, a CSI-RS, or an SRS on an SRS resource basis.

When SRS-SpatialRelationInfo is configured for the SRS resource, an SRS is transmitted using the same beamforming as the beamforming used for the SSB, the CSI-RS, or the SRS. However, when SRS-SpatialRelationInfo is not configured for the SRS resource, the UE randomly determines Tx beamforming and transmit the SRS using the determined Tx beamforming (S1330).

More specifically, for a P-SRS for which ‘SRS-ResourceConfigType’ is set to ‘periodic’:
i) When SRS-SpatialRelationInfo is set to ‘SSB/PBCH’, the UE transmits the SRS by applying the same spatial domain Tx filter as (or generated from) a spatial domain Rx filter used for reception of an SSB/PBCH; or
ii) When SRS-SpatialRelationInfo is set to ‘CSI-RS’, the UE transmits the SRS by applying the same spatial domain Tx filter as used for reception of a CSI-RS; or
iii) When SRS-SpatialRelationInfo is set to ‘SRS’, the UE transmits the SRS by applying the same spatial domain Tx filter as used for transmission of an SRS.
Additionally, the UE may or may not receive a feedback for the SRS from the BS, as in the following three cases (S1340).
i) When Spatial_Relation_Info is configured for all SRS resources in an SRS resource set, the UE transmits the SRS by a beam indicated by the BS. For example, when the Spatial_Relation_Info indicates the same SSB, CRI, or SRI, the UE repeatedly transmits the SRS on the same beam.
ii) Spatial_Relation_Info may be configured for none of the SRS resources in the SRS resource set. In this case, the UE may transmit the SRS by freely changing SRS beamforming.
iii) Spatial_Relation_Info may be configured only for some SRS resources in the SRS resource set. In this case, the UE may transmit the SRS by an indicated beam, for SRS resources for which Spatial_Relation_Info is configured, whereas the UE may transmit the SRS by applying random Tx beamforming, for the SRS resources for which Spatial_Relation_Info is not configured.

In the proposed methods described later, a beam may refer to an area for performing a specific operation (e.g., LBT or a transmission) by concentrating power in a specific direction and/or a specific space. In other words, the UE or the BS may perform an operation such as LBT or a transmission by targeting a specific area (i.e., beam) corresponding to a specific space and/or a specific direction. Therefore, each beam may correspond to a space and/or a direction. Further, to use each beam, the UE or the BS may use a spatial domain filter corresponding to the space and/or direction corresponding to the beam. That is, one spatial domain filter may correspond to one or more beams, and the UE or the BS may perform an operation such as LBT or a transmission using a spatial domain filter corresponding to a beam (or space and/or direction) that it wants to use.

For example, the UE or the BS may perform LBT in a space and/or direction for an LBT beam using a spatial domain filter corresponding to the LBT beam, or perform a DL/UL transmission to a space and/or direction for a Tx beam using the spatial domain filter corresponding to the Tx beam.

### Dynamic Slot Format Indication Information (e.g., DCI Format 2_0)

Basically, a slot format indicates per-symbol usages in a given slot, indicating one of downlink (D), uplink (U), or flexible (F) for each symbol. Slot format-related information may be transmitted in one or more of the following signals:

Static or semi-static slot format indication (SFI) by higher-layer signaling (e.g., TDD-UL-DL-ConfigurationCommon and/or TDD-UL-DL-ConfigDedicated);

Measurement-related scheduling signal (e.g., measurement-related signal configured by UE-specific RRC signaling);

Dynamic SFI (e.g., signal transmitted in DCI format 2_0); and

UE-specific data transmission scheduling signal (e.g., UE-specific DCI).

The static or semi-static SFI may be indicated by cell-specific RRC signaling (e.g., TDD-UL-DL-ConfigurationCommon) or UE-specific RRC signaling (e.g., TDD-UL-DL-ConfigDedicated). The measurement-related signal may be indicated by UE-specific RRC signaling, and indicate a periodic/semi-persistent CSI-RS for CSI reporting, periodic CSI reporting, a periodic/semi-persistent SRS, or the like. The UE-specific data transmission-related signal may include UE-specific DCI that triggers a PDSCH, a PUSCH, or a PUCCH with A/N for a PDSCH, and DCI that triggers an aperiodic measurement-related signal such as an aperiodic CSI-RS, an aperiodic SRS, or the like.

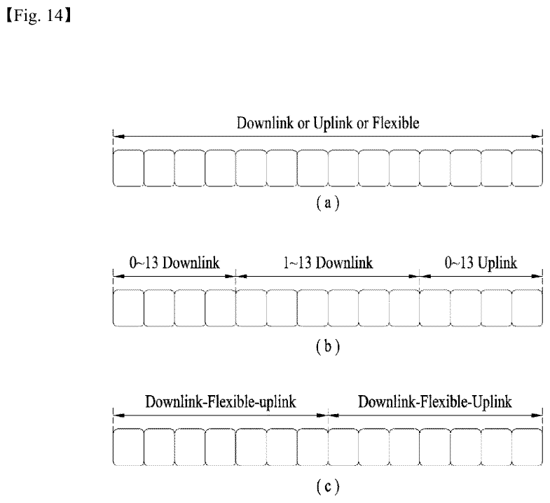

The slot format includes a format for zero, one, or two switching points. FIG. E1 illustrates various slot formats. Specifically, FIG. 14(a) illustrates a slot format for zero switching points, FIG. 14(b) illustrates a slot format for one switching point, and FIG. 14(c) illustrates a slot format for two switching points.

The slot format for zero switching points includes 14 DL symbols, 14 flexible symbols, or 14 UL symbols. The slot format for one switching point is configured to start with zero or more DL symbols and end with zero or more UL symbols, with one or more flexible symbols and DL/UL symbols in between. The slot format for two switching points includes first seven symbols starting with zero or more DL symbols and including one or more UL symbols ending in a 7^{th} symbol, and second seven symbols starting with one or more DL symbols and ending with zero or more UL symbols. The first seven symbols and the second seven symbols may each include zero or more flexible symbols.

Up to 256 slot formats may be defined, and their configurations are defined by a standard document such as TS 38.211. The UE is configured with a UE-specific SFI table based on the up to 256 slot formats by higher-layer signaling and receives a specific index value in the UE-specific SFI table through DCI format 2_0 (or a group-common PDCCH).

The UE determines a slot format based on the following prioritization of signals carrying the above-described slot format-related information. More specifically, when the UE receives slot format-related information through a plurality of signals, the UE considers indication information in signals prioritized as follows, only for the purpose of determining the usage of a symbol indicated as a flexible symbol by a high-priority signal.

“Slot format information by cell-specific higher-layer signaling (e.g., TDD-UL-DL-ConfigurationCommon)>slot format information by UE-specific higher-layer signaling (e.g., TDD-UL-DL-ConfigDedicated)>slot format information through a group common PDCCH (e.g., DCI format 2_0)>UE-specific data transmission scheduling information>measurement-related scheduling information.”

Therefore, when a specific symbol in a slot is indicated as DL/UL to the UE by cell-specific RRC signaling or UE-specific RRC signaling, the UE does not expect DCI format 2_0 (or a group-specific PDCCH including DCI format 2_0) to indicate the specific symbol as UL/DL or flexible. When the DCI format 2_0 (or the group-specific PDCCH including DCI format 2_0) indicates the specific symbol in the slot as a flexible symbol, the UE transmits or receives a related signal in the specific symbol only when receiving separate scheduling information (e.g., UE-specific scheduling DCI), and otherwise, does not perform the signal transmission/reception in the specific symbol.

Further, the DCI format 20 (or the group specific PDCCH including DCI format 2_0) may further include information about available RB set(s), a channel occupancy time (COT) duration, and switching of a search space set group. Specifically, the DCI format 20 may include one or more of the following pieces of information. The CRC of the DCI format 2_0 may be scrambled with a UE group-common ID (e.g., SFI-RNTI). The size of the DCI format 20 may be configurable to be up to 128 bits by a higher layer (e.g., the RRC layer).
Slot format indicator 1, Slot format indicator 2, . . . , Slot format indicator N.
When the higher-layer parameter availableRB-SetPerCell is configured,
Available RB set Indicator 1, Available RB set Indicator 2, . . . , Available RB set Indicator N1,
If the higher-layer parameter CO-DurationPerCell is configured,
COT duration indicator 1, COT duration indicator 2, . . . , COT duration indicator N2.
If the higher layer parameter searchSpaceSwitchTrigger is configured,
Monitoring group flag 1, Monitoring group flag 2, . . . , Monitoring group flag M.

An RB set corresponds to frequency resources in which a channel access process (CAP) is performed individually in a shared spectrum, and includes a plurality of contiguous (P)RBs. An available RB set indicator indicates the index of an RB set in which DL reception is available within a cell. A COT duration indicator indicates a COT shared between the BS and the UE in the shared spectrum. A monitoring group flag indicates a search space group to be monitored by the UE among a plurality of search space groups (e.g., group #0/#1) configured for the same cell. DCI format 2_0 is group-common control information, and the position (e.g., start point) of information for each UE may be indicated by higher-layer (e.g., RRC) signaling. For example, availableRB-SetPerCell is a UE-specific signal, and may include information about the position (e.g., start point) of an available RB set indicator for the UE in the DCI format 2_0. Similarly, CO-DurationPerCell and searchSpaceSwitchTrigger are also UE-specific signals and may each include information about the position (e.g., start point) of information for the UE in the DCI format 2_0.

For a high frequency band of 52.6 GHz or higher, in view of greater path loss than in a low frequency band, directional LBT (hereinafter, referred to as D-LBT), in which LBT is performed only in a specific direction, and directional transmission/reception may be considered in addition to omni-directional LBT (hereinafter, referred to as O-LBT), in which LBT is performed omni-directionally through a technique such as analog beamforming using multiple antennas, and omni-directional transmission/reception.

Channel occupancy (CO) that the UE or the BS acquires by performing LBT in a specific beam direction may be shared with the BS or the UE (i.e., COT sharing). The BS or the UE sharing the CO acquired by the UE or the BS may transmit a DL/UL channel by performing Cat-1 LBT in which a transmission is performed without LBT, or Cat-2 LBT in which only short channel sensing is performed, rather than random backoff-based LBT (e.g., Cat-3 LBT or Cat-4 LBT). In this case, since the CO is acquired by performing LBT in the specific beam direction, COT sharing is only available when there is a QCL relationship with the beam direction in which the LBT was performed. Therefore, the disclosure proposes a method of including beam-related information about CO in a group common-physical downlink control channel (GC-PDCCH) (e.g., DCI format 2_0) or configured grant-uplink control information (CG-UCI) and performing COT sharing based on the information.

A representative channel access procedure performed for transmission in an unlicensed band is LBT. LBT is a mechanism in which the interference level of the surroundings measured by a BS and/or a UE to transmit a signal is compared with a specific threshold such as an energy detection (ED) threshold, and when a noise level is equal to or lower than a certain level, transmission of the signal is allowed, thereby avoiding collision between transmissions.

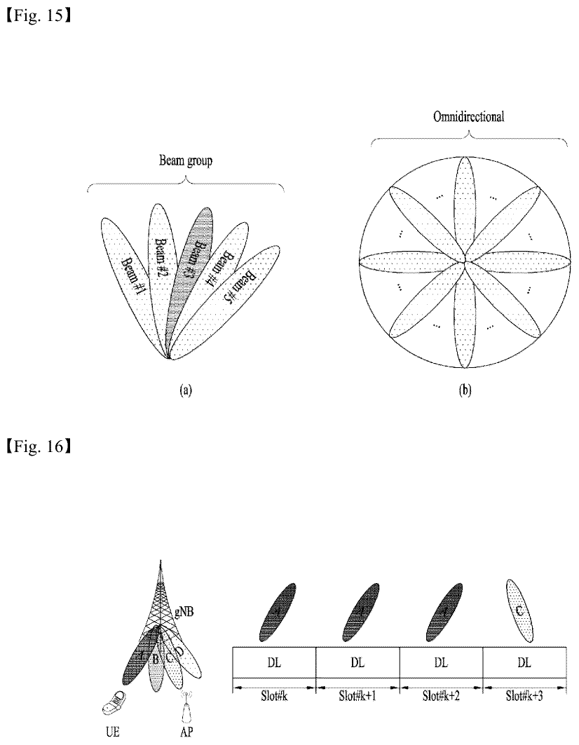

FIG. 15 illustrates an example of directional LBT and omni-directional LBT.

FIG. 15(a) illustrates directional LBT including specific beam direction LBT and/or beam group-based LBT, and FIG. 15(b) illustrates omni-directional LBT.

In the legacy NR-U system (e.g., Rel-16 NR-U), when a channel is determined to be idle in a CAP (i.e., LBT), a DL/UL signal/channel is transmitted, as described with reference to FIG. 7. In the legacy NR-U system, an LBT band is matched with other RATs (e.g., Wi-Fi), for compatibility with the other RATs, and a CAP (i.e., LBT) is performed omni-directionally. In other words, non-directional LBT is performed in the legacy NR-U system.

However, in Rel-17 NR-U for transmitting a DL/UL signal/channel in a higher band (e.g., 52.6 GHz or higher) than in an unlicensed band of 7 GHz used in the legacy NR-U system, directional LBT (D-LBT) in which a transmission is performed by concentrating energy in a specific beam direction may be used to overcome greater path loss than in the legacy 7 GHz band. In other words, Rel-17 NR-U enables transmission of a DL/UL signal/channel over wider coverage and increases efficiency for co-existence with other RATs (e.g., WiGig) by reducing path loss through D-LBT.

Referring to FIG. 15(a), when a beam group includes beam #1 to beam #5, performing LBT based on beam #1 to beam #5 may be referred to as beam group-based LBT. Additionally, performing LBT through any one (e.g., beam #3) of beam #1 to beam #5 may be referred to as specific beam direction LBT. Beam #1 to beam #5 may be continuous (or adjacent) beams or discontinuous (or non-adjacent) beams. Further, a beam group does not necessarily include a plurality of beams, and a single beam may form one beam group.

LBT may be performed on a beam basis or on a beam group basis. For example, when LBT is performed on a beam basis, each of beam #1 to beams #5 may cover one of a plurality of transmission beams multiplexed in time domain multiplexing (TDM) and/or spatial domain multiplexing (SDM). For example, beam #1 may cover transmission beam #1 among a plurality of transmission beams multiplexed in TDM and/or SDM, beam #2 may cover transmission beam #2 among the plurality of transmission beams, beam #3 may cover transmission beam #3 among the plurality of transmission beams, beam #4 may cover transmission beam #4 among the plurality of transmission beams, and beam #5 may cover transmission beam #5 among the plurality of transmission beams. Herein, cover may mean that the area of a beam for performing LBT includes or is at least the same as an area where a transmission beam corresponding to the beam has effective influence (or interference).

In other words, this may mean performing energy measurement through a sensing beam for performing LBT, which covers an area affected by interference from a transmission beam. Further, it may be determined whether a channel is idle/busy by comparing energy measured through the sensing beam with an ED threshold.

In another example, performing LBT on a beam group basis may mean performing LBT for each beam group at once for a plurality of TDM and/or SDM transmission beams corresponding to beams included in the beam group. That is, one beam (hereinafter, referred to as a group LBT beam) may be formed for a beam group, and LBT may be performed on all of a plurality of transmission beams at once using the group LBT beam.

Accordingly, the group LBT beam may cover all transmission beams (e.g., transmission beam #1 to transmission beam #5) corresponding to the beam group. For example, it may mean that the area of the group LBT beam includes all of areas where the respective transmission beams (e.g., transmission beam #1 to transmission beam #5) have effective influence (or interference), or is at least the same as the areas.

FIG. 15(b) illustrates omni-directional LBT. When omni-directional beams form one beam group and LBT is performed on a beam group basis, it may be considered as omni-directional LBT. In other words, when beams in all directions, that is, omni-directional beams, which are a set of beams covering a specific sector in a cell, are included in one beam group, this may mean omni-directional LBT.

In other words, coverage may be limited due to greater path loss in a high frequency band. To overcome this coverage problem, a multi-antenna technique may be used. For example, a narrow beam transmission may be performed, which is a signal transmission by concentrating energy in a specific direction rather than an omni-directional transmission.

In the high-frequency unlicensed band, a beam-based transmission and a channel access procedure such as the above-described LBT need to be considered together. For example, to perform directional LBT (D-LBT) in a specific direction, the directional LBT may be performed in the specific direction or LBT may be performed on the basis of a beam group including a beam in the specific direction. Through the LBT, it may be determined whether a channel is occupied (i.e., whether the channel is idle/busy) and then a transmission may be performed accordingly. The beam group may include one or more beams, and when it includes omni-directional beams, the LBT may be extended to omni-directional LBT (O-LBT).

Before a description of proposed methods, NR-based channel access schemes for an unlicensed band used in the disclosure are classified as follows.

Category 1 (Cat-1): Within a COT, the next transmission is performed immediately after a short switching gap from the end of the previous transmission, and this switching gap is shorter than a certain length (e.g. 3 us) and includes even a transceiver turnaround time. Cat-1 LBT may correspond to Type 2C CAP described above.

Category 2 (Cat-2): an LBT method without backoff. Once a channel is confirmed to be idle during a specific time period shortly before transmission, the transmission may be performed immediately. Cat-2 LBT may be subdivided according to the length of a minimum sensing duration required for channel sensing immediately before a transmission. For example, Cat-2 LBT with a minimum sensing duration of 25 us may correspond to the above-described Type 2A CAP, and Cat-2 LBT with a minimum sensing duration of 16 us may correspond to the above-described Type 2B CAP. The minimum sensing durations are merely exemplary, and a minimum sensing duration less than 25 us or 16 us (e.g., a minimum sensing duration of 9 us) may also be available.

Category 3 (Cat-3): an LBT method with fixed contention window size (CWS)i-based backoff A transmitting entity selects a random number N in a range of 0 to a (fixed) maximum CWS value and decrements a counter value each time it determines that a channel is idle. When the counter value reaches 0, the transmitting entity is allowed to perform a transmission.

Category 4 (Cat-4): an LBT method with variable CWS-based backoff A transmitting entity selects a random number N in a range of 0 to a (variable) maximum CWS value and decrements a counter value, each time it determines that a channel is idle. When the counter value reaches 0, the transmitting entity is allowed to perform a transmission. If the transmitting entity receives a feedback indicating reception failure of the transmission, the transmitting entity increases the maximum CWS value by one level, selects a random number again within the increased CWS value, and performs an LBT procedure. Cat-4 LBT may correspond to the above-described Type 1 CAP.

In the disclosure, a beam-based or beam group-based LBT procedure may basically refer to a backoff-based LBT procedure (e.g., Cat-3 LBT or Cat-4 LBT). Further, in beam-based LBT, carrier sensing may be performed in a specific beam direction, and measured energy is compared with an ED threshold. When the measured energy is lower than the ED threshold, a channel in the beam direction may be determined to be idle, whereas when the measured energy is higher than the ED threshold, the channel in the beam direction may be determined to be busy.

The beam group-based LBT procedure is to perform the same LBT procedure as described above for all beam directions included in a beam group, except that when a beam in a specific preset/indicated direction in the beam group is set as a representative beam, a random backoff-based LBT procedure (e.g., Cat-3 LBT or Cat-4 LBT) is performed for the representative beam, similarly to multi-CC LBT, while Cat-2 LBT is performed for the remaining beams of the beam group, so that a signal is transmitted upon success.

For the following reason, it may be preferable to configure all DL signals/channels (or UL signals/channels) in a single Tx burst as spatially (partially) QCLed signals/channels. For example, as illustrated in FIG. 16, in transmitting a Tx burst including a total of four slots after successful LBT, the BS may transmit the Tx burst in the direction of beam A during three slots and then transmit it in the direction of beam C during the 4^{th} slot.

However, while the BS is transmitting the signal in the direction of beam A, a Wi-Fi access point (AP) co-existing in a corresponding U-band may not detect the signal transmitted in the direction of beam A, determine that a channel is idle, and start transmitting and receiving a signal, upon success of LBT. When the BS transmits the signal in the direction of beam C from slot #k+3, the signal may interfere with the Wi-Fi signal. As such, when the BS transmits a signal by changing the direction of beam A to another beam direction without additional LBT, this may interfere with another co-existing wireless node. Accordingly, it may be preferable for the BS not to change the Tx beam direction of a Tx burst after success of LBT.

In the NR system, a method of signaling beam information to be used by a UE for a UL transmission/reception by associating a DL signal with a UL signal is considered. For example, in the case where a CSI-RS resource is associated with an SRS resource, and there is a beam direction generated by the UE in the CSI-RS resource, when the UE transmits an SRS in the SRS resource linked to the CSI-RS resource (or when the UE transmits a PUSCH scheduled by a UL grant signaling the SRS resource linked to the CSI-RS resource), the UE may transmit the UL signal using a Tx beam corresponding to a CSI-RS Rx beam. When the UE has the beam correspondence capability, the relationship between the specific Rx beam and the specific Tx beam may be established by implementation of the UE. Alternatively, when the UE does not have the beam correspondence capability, the relationship between the specific Rx beam and the specific Tx beam may be established by training between the BS and the UE.

Accordingly, when an association relationship is defined between a DL signal and a UL signal, it may be allowed to share a COT between a DL Tx burst including DL signals/channels spatially (partially) QCLed with the DL signal and a UL TX burst including UL signals/channels spatially (partially) QCLed with the UL signal associated with the DL signal.

The term UL signal/channel may include at least one of the following signals/channels.

SRS, DMRS for PUCCH, DMRS for PUSCH, PUCCH, PUSCH and PRACH

The term DL signal/channel may include at least one of the following signals/channels.

Primary synchronization signal (PSS), secondary SS (SSS), DMRS for PBCH, PBCH, tracking reference signal (TRS) or CSI-RS for tracking, CSI-RS for CSI acquisition and CSI-RS for RRM measurement, CSI-RS for beam management, DMRS for PDCCH, DMRS for PDSCH, PDCCH (or control resource set (CORESET) in which the PDCCH may be transmitted), PDSCH, and any of the above listed signals or variations thereof, or any newly introduced signal, which is placed before a Tx burst for the purpose of tracking or (fine) time/frequency synchronization or co-existence or power saving or frequency reuse factor=1.

The BS may configure the UE with spatialrelationinfo for a beam direction to be transmitted by the UE, or when a Rel-17 unified TCI framework is supported, indicate a beam direction for a UL transmission to the UE by a joint TCI state.

Spatialrelationinfo may include SSB/CSI-RS/SRS. When Spatialrelationinfo is set to SSB/CSI-RS, it may be interpreted as an indication to use the same spatial domain filter as an SSB/CSI-RS Rx beam, for a transmission. Further, when Spatialrelationinfo is set to SRS, it may be interpreted as an indication to use the same beam as a Tx beam used for an SRS transmission based on spatialrelatioinfo configured for each SRS resource ID when an SRS resource is configured. Further, when a unified TCI state is supported, a beam direction may be indicated by a joint TCI, and in the case of a DL/UL separate TCI, a beam direction may be indicated by a UL TCI state. Further, when a specific DL RS is indicated by a joint TCI, this may imply that a beam corresponding to a corresponding DL RS Rx beam may also be used for a transmission. For example, when the specific DL RS is indicated by the joint TCI, a beam using the same spatial filter as the DL RS Rx beam may also be used for the transmission.

Each of the following proposed methods may be combined and applied with other proposed methods, unless they contradict each other.

In a high frequency band, directional transmission/reception using beamforming is considered in addition to omni-directional transmission/reception using a multi-antenna technique to overcome high path loss. For an unlicensed band, implementation of a spectrum sharing mechanism such as LBT may be mandated according to national/regional regulations.

Further, directional LBT is also considered, in which LBT is performed only in a specific beam direction rather than omni-directionally, for a transmission/reception in a specific direction. Therefore, the BS/UE may determine whether a channel is occupied (e.g., idle/busy) by using an appropriate LBT beam (i.e., sensing beam) to cover an interference range of a Tx beam to be transmitted, and then transmit the channel if LBT is successful. When it is said that LBT is successful, this may mean that the energy measurement of the channel according to the LBT is less than an energy detection (ED) threshold, and thus the channel is determined to be idle. Further, since a plurality of Tx beams may be transmitted in SDM/TDM in a COT acquired by LBT, LBT may be performed for a single wide beam or each individual beam ((multiple) independent per-beam LBT), such that an LBT beam (i.e., sensing beam) may cover all of the plurality of beams.

CO that the UE or the BS acquires by performing single-wide beam LBT or independent per-beam LBT in a specific beam direction may be shared with the BS or the UE. This COT sharing operation, which is also available in Rel-16 NR-U, means that in the case where the UE is configured/indicated to perform random backoff-based LBT (e.g., Cat-3 LBT or Cat-4 LBT) before a transmission, when identifying that the transmission is included in (frequency and time resources of) a COT of the BS by a GC-PDCCH (e.g., DCI format 2_0), the UE may switch to Cat-1 LBT or Cat-2, thereby increasing a relative channel access probability.

When it said that the transmission is in a COT of the BS, this may mean that the COT includes frequency resources and time resources of a channel to be transmitted by the UE.

However, because CO is acquired by performing LBT only in a specific beam direction rather than omni-directionally in a high frequency unlicensed band as described before, COT sharing is available only when the Tx beam of a channel to be transmitted should be QCLed with the beam direction in which the LBT has been performed as well as the frequency resources and time resources of the channel to be transmitted should be included in the COT. That is, for the high frequency unlicensed band, the spatial domain-related condition should be added.

In the disclosure, a high frequency unlicensed band in which a UE or a BS operates may refer to a band of 52.6 GHz or higher. For example, it may refer to a band from 52.6 GHz to 71 GHz. Further, the high frequency unlicensed band of the disclosure is for a shared spectrum, and may be referred to as a band of frequency range 2-2 (FR 2-2).

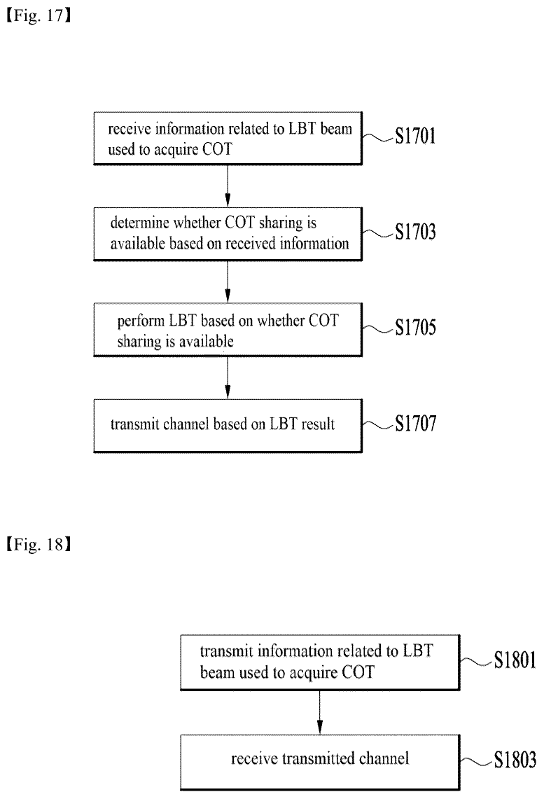

FIGS. 17 to 19 are diagrams illustrating an overall process of operating a UE and a BS according to the disclosure.

FIG. 17 illustrates an operation process when a UE or a BS serves a transmitting end that transmits a UL/DL channel according to [Method #1] or [Method #2] of the disclosure.

The UE or the BS may receive information related to an LBT beam that the BS or the UE has used to acquire a COT (S1701). The information related to the LBT beam may be included in a GC-PDCCH or CG-UCI.

The UE or the BS may determine whether COT sharing is available, based on the information related to the LBT beam (S1703). The UE or the BS may perform LBT using Cat-1 LBT, Cat-2 LBT, Cat-3 LBT, or Cat-4 LBT based on whether the COT sharing is available (S1705), and transmit a UL/DL channel when a channel corresponding to the LBT is determined to be idle (S1707).

When the UE is responsible for performing the operation of FIG. 17, a detailed method of operating the UE may be based on [Method #1]. On the contrary, when the BS is responsible for performing the operation of FIG. 17, a detailed method of operating the BS may be based on [Method #2].

FIG. 18 illustrates an operation process when a BS or a UE serves as a receiving end that receives a UL/DL channel according to [Method #1] or [Method #2] of the disclosure.

The BS or the UE may transmit information related to an LBT beam that it has used to acquire a COT (S1801). The information related to the LBT beam may be included in a GC-PDCCH or CG-UCI. Further, the BS or the UE may receive a UL/DL channel (S1803).

When the BS is responsible for performing the operation of FIG. 18, a detailed method of operating the BS may be based on [Method #1]. On the contrary, when the UE is responsible for performing the operation of FIG. 18, a detailed method of operating the UE may be based on [Method #2].

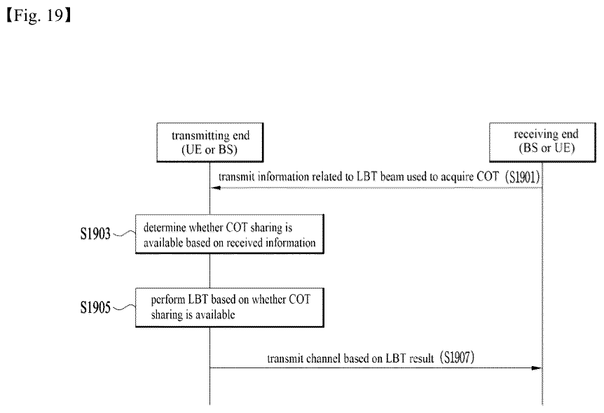

FIG. 19 illustrates an operation process in which a UE or a BS transmits and receives a UL/DL channel according to [Method #1] or [Method #2] of the disclosure.

The BS or the UE may transmit information related to an LBT beam that it has used to acquire a COT to the UE or the BS (S1901). The information related to the LBT beam may be included in a GC-PDCCH or CG-UCI. The UE or the BS may determine whether COT sharing is available based on the information related to the LBT beam (S1903). The UE or the BS may perform LBT using Cat-1 LBT, Cat-2 LBT, Cat-3 LBT, or Cat-4 LBT based on whether the COT sharing is available (S1905), and transmit a UL/DL channel when a channel corresponding to the performed LBT is determined to be idle (S1907).

When the transmitting end of FIG. 19 is the UE and the receiving end is the BS, a detailed method of operating the UE and the BS may be based on [Method #1]. On the contrary, when the transmitting end of FIG. 19 is the BS and the receiving end is the UE, a detailed method of operating the UE and the BS may be based on [Method #2].

[Method #1] when a GC-PDCCH (e.g., DCI Format 2_0) May Include Information Related to an LBT Beam Used to Acquire a COT, Such as Spatialrelationinfo (e.g., an SSB Index, a CSI-RS Index, or an SRI) or a Rel-17 Unified TCI Framework (e.g., a Joint TCI State) or a Separately Set Index, a UE Receiving the GC-PDCCH May Determine Whether COT Sharing is Available or Switch an LBT Type Indicated by a BS by Considering a QCL Relationship Between a UL Signal/Channel (e.g., a DG-PUSCH, a CG-PUSCH, an SRS, a PUCCH, or an RACH) to be Transmitted by the UE and the Information Related to the LBT Beam.

When information or a field related to an LBT beam is not configured in a GC-PDCCH (e.g., DCI format 2_0), it may be determined by default whether COT sharing is available depending on whether the QCL source of a CORESET beam on which the GC-PDCCH (e.g., DCI format 2_0) is transmitted coincides with the QCL source RS of a UL signal/channel. The QCL source of the CORESET beam may be configured as a CSI-RS, or in the case of CORESET #0, the QCL source may be linked to an SSB index.

When the information related to the LBT beam included in the GC-PDCCH (e.g., DCI format 2_0) received by the UE or the QCL source linked to the CORSET beam is
(1) SSB index: the UE may share a COT for a UL signal/channel with a QCL source RS or QCL top source RS having the same SSB index as the SSB index among UL signals/channels to be transmitted by the UE.
(2) CSI-RS index: the UE may share a COT for a UL signal/channel with a QCL source RS having the same CSI-RS index as the CSI-RS index among UL signals/channels to be transmitted by the UE.
(2) SRS resource indicator (SRI): the UE may share a COT for a UL signal/channel with the same QCL source RS as the SRI among UL signals/channels to be transmitted by the UE. When the QCL resource RS of the SRI is an SSB, the UE may share the COT for a UL signal/channel with a QCL top source RS having the same index as the SSB among the UL signals/channels.
(4) Transmission configuration indicator (TCI): (especially Rel-17 joint TCI), the UE may share a COT for a UL signal/channel linked to an index value equal to the index of the TCI among UL signals/channels to be transmitted by the UE.
(5) Separately set index: the BS may separately configure UL signals/channels to be linked to the index, and the UE may share a COT for a UL signal/channel linked to the same index.

COT sharing means that the remainder of a COT acquired by the BS is transferred to the UE after a DL transmission is completed in the COT, and the UE is allowed to perform a UL transmission after performing Cat-1 LBT or Cat-2 LBT in the remaining COT. For example, it is assumed that the BS performs a DL transmission of 3 ms within a COT of 5 ms acquired by performing LBT in the direction of LBT beam A. In this case, (i) when the UE is aware through a GC-PDCCH that the QCL top source RS of LBT Beam A used by the BS to acquire the COT is SSB index 1, and the SSB index of the QCL top source RS of a UL signal/channel (e.g., PUSCH) to be transmitted by the UE is also SSB index 1, (ii) frequency resources used for the DL transmission are the same as or include frequency resources for the UL transmission, and (iii) the BS indicates to the UE that the remaining 2-ms COT is available for the UL transmission by the GC-PDCCH, even if the UE is indicated to perform random backoff-based LBT (e.g., Cat-3 LBT or Cat-4 LBT) for the PUSCH transmission, the UE may switch the LBT type to Cat-1 LBT or Cat-2 LBT, perform it, and then use the remaining 2 ms for the UL transmission.

When (i) the QCL top source of the UL signal/channel (e.g., PUSCH) to be transmitted by the UE and the QCL top source of the LBT beam of the BS have different SSB indexes, or (ii) the UL transmission resources are not included in the DL transmission resources, or (iii) the sum of the duration of the DL transmission and the duration of the UL transmission to be performed is greater than MCOT=5 ms (i.e., the duration of the UL transmission is longer than the remaining COT of 2 ms), the UE may neither switch the indicated LBT type nor share the COT. For example, when the UE is indicated to perform random backoff-based LBT (e.g., Cat-3 LBT or Cat-4 LBT) to transmit the PUSCH in the above case, the UE should transmit the PUSCH after performing the random backoff-based LBT (e.g., Cat-3 LBT or Cat-4 LBT).

When the QCL source RS of a TCI state linked to a CORESET is a DL RS (e.g., a CSI-RS or a TRS) other than an SSB, the QCL source RS of another TCI state linked to the QCL source RS may be detected, and a last configured QCL source RS detected by continuously tracking such linked QCL source RSs is a QCL top source. For example, when the QCL source RS of a DMRS is configured as a CSI-RS, the QCL source RS of the CSI-RS is configured as a TRS, and the QCL source RS of the TRS is configured as an SSB, then the QCL top source of the DMRS is the SSB, which is the QCL source RS of the TRS.

[Method #2] when CG-UCI May Include Information Related to an LBT Beam Used to Acquire a COT, Such as Spatialrelationinfo (e.g., an SSB Index, a CSI-RS Index, or an SRI) or a Rel-17 Unified TCI Framework (e.g., a Joint TCI State) or a Separately Set Index, a BS Receiving the CG-UCI May Determine Whether COT Sharing is Available or Switch an LBT Type to be Performed by the BS by Considering a QCL Relationship Between a DL Signal/Channel (e.g., a PDCCH, a PDSCH, a CSI-RS, or an SSB) to be Transmitted by the BS and the Information Related to the LBT Beam.

When information related to an LBT beam included in CG-UCI in a CG-PUSCH received by the BS is
(1) SSB index: the BS may share a COT for a DL signals/channel with a QCL source RS or QCL top source RS having the same SSB index as the SSB index among DL signals/channels to be transmitted by the BS.
(2) CSI-RS index: the BS may share a COT for a DL signals/channel with a QCL source RS or QCL top source RS having the same CSI-RS index as the CSI-RS index among DL signals/channels to be transmitted by the BS.
(3) SRI: the BS may share a COT for a DL signals/channel with the same QCL source RS as the SRI among DL signals/channels to be transmitted by the BS. When the QCL source RS of the SRI is an SSB, the BS may share the COT for a DL signal/channel with a QCL top source RS having the same index as the SSB among the DL signals/channels.
(4) TCI: (especially, Rel-17 joint TCI), the BS may share a COT for a DL signal/channel linked to the same index value as the index of the TCI among DL signals/channels to be transmitted by the BS.
(5) Separately set index: the BS may separately configure DL signals/channels to be linked to the index, and share a COT for a DL signal/channel linked to the same index.

Alternatively, when the BS performs Cat-1 LBT or Cat-2 LBT by an LBT beam covering a signal corresponding to (1) to (4) above and succeeds in Cat-1 LBT or Cat-2 LBT, the BS may perform a DL transmission by COT sharing. For example, a CSI-RS index is included in CG-UCI, and for a DL signal/channel with a QCL source RS having the same CSI-RS index as included in the CG-UCI among DL signals/channels to be transmitted by the BS, the LBT beam covering the signal may be an LBT beam corresponding to an SSB which is the QCL top source RS of the CSI-RS. Further, the LBT beam may include a beam having a relatively wide beam width and thus corresponding to the CSI-RS.

When the CG-UCI does not include the information related to the LBT beam, or a field related to the LBT beam is not configured, the BS may perform Cat-2 LBT using an LBT beam covering a signal such as an RS configured in CG resources preconfigured for a CG-PUSCH transmission, and then transmit the DL signal/channel.

COT sharing means that the remainder of a COT acquired by the UE is transferred to the BS after a UL transmission is completed in the COT, and the BS is allowed to perform a DL transmission after performing Cat-1 LBT or Cat-2 LBT in the remaining COT. For example, it is assumed that the UE performs a UL transmission of 3 ms within a COT of 5 ms acquired by performing LBT in the direction of LBT beam A. In this case, (i) when the BS is aware through CG-UCI transmitted multiplexed with a CG-PUSCH that the QCL top source RS of LBT Beam A used by the UE to acquire the COT is SSB index 1, and the SSB index of the QCL top source RS of a DL signal/channel (e.g., PDSCH) to be transmitted by the BS is also SSB index 1, (ii) frequency resources used for the UL transmission are the same as or include frequency resources for the DL transmission, and (iii) the UE indicates to the BS that the remaining 2-ms COT is available for the DL transmission by the CG-UCI, the BS may perform Cat-1 LBT or Cat-2 LBT by LBT type switching, instead of random backoff-based LBT (e.g., Cat-3 LBT or Cat-4 LBT) for the PDSCH transmission, and then use the remaining 2 ms for the DL transmission.

When (i) the QCL top source of the DL signal/channel (e.g., PDSCH) to be transmitted by the BS and the QCL top source of the LBT beam of the UE have different SSB indexes, or (ii) the DL transmission resources are not included in the UL transmission resources, or (iii) the sum of the duration of the UL transmission and the duration of the DL transmission to be performed is greater than MCOT=5 ms (i.e., the duration of the DL transmission is longer than the remaining COT of 2 ms), the BS may neither switch the LBT type nor share the COT. For example, in the above case, the BS should transmit the PDSCH after performing random backoff-based LBT (e.g., Cat-3 LBT or Cat-4 LBT).

When the QCL source RS of a TCI state linked to a CORESET is a DL RS (e.g., a CSI-RS or a TRS) other than an SSB, the QCL source RS of another TCI state linked to the QCL source RS may be detected, and a last configured QCL source RS detected by continuously tracking such linked QCL source RSs is a QCL top source. For example, when the QCL source RS of a DMRS is configured as a CSI-RS, the QCL source RS of the CSI-RS is configured as a TRS, and the QCL source RS of the TRS is configured as an SSB, then the QCL top source of the DMRS is the SSB, which is the QCL source RS of the TRS.

The disclosure may be used for direct communication between UEs as well as for UL and/or DL, and the proposed methods may be used in a BS or a relay node.

It will be appreciated that any of examples of the above-described proposed methods may also be included as one of the embodiments and thus considered to be a kind of proposed method. Further, the above-described proposed methods may be implemented independently, and some of them may also be implemented as a combination (or merged). It may be regulated that the BS indicates to the UE whether to apply the proposed methods (or information about rules for the proposed methods) through a predefined signal (e.g., a physical-layer signal or a higher-layer signal).

The various descriptions, functions, procedures, proposals, methods, and/or operation flowcharts of the disclosure described herein may be applied to, but not limited to, various fields requiring wireless communication/connectivity (e.g., 5G) between devices.

More specific examples will be described below with reference to the drawings. In the following drawings/description, like reference numerals denote the same or corresponding hardware blocks, software blocks, or function blocks, unless otherwise specified.

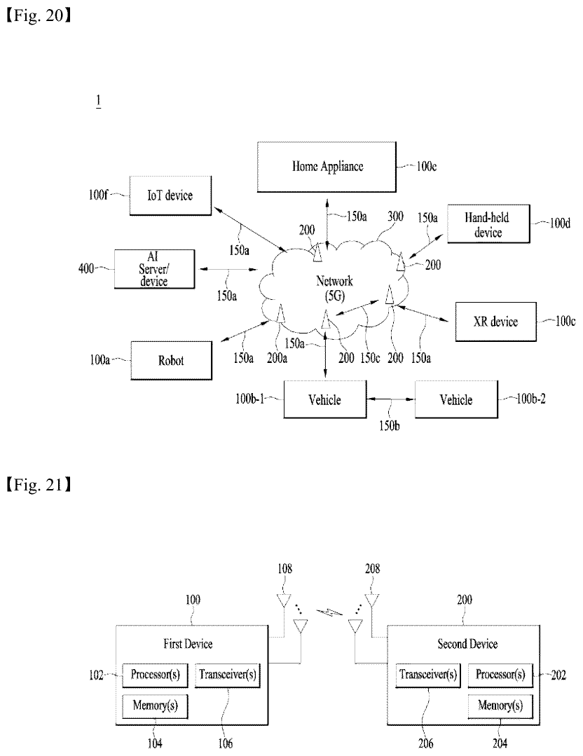

FIG. 20 illustrates a communication system 1 applied to the disclosure.

Referring to FIG. 20, the communication system 1 applied to the disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smartpad, a wearable device (e.g., a smartwatch or smartglasses), and a computer (e.g., a laptop). The home appliance may include a TV, a refrigerator, a washing machine, and so on. The IoT device may include a sensor, a smartmeter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g. V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g. relay or integrated access backhaul (IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the disclosure.

FIG. 21 illustrates wireless devices applicable to the disclosure.

Referring to FIG. 21, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 20.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the disclosure, the wireless device may be a communication modem/circuit/chip.

Specifically, instructions and/or operations, controlled by the processor 102 of the first wireless device 100 and stored in the memory 104 of the first wireless device 100, according to an Embodiment of the disclosure will be described.

Although the following operations will be described based on a control operation of the processor 102 in terms of the processor 102, software code for performing such an operation may be stored in the memory 104. For example, in the disclosure, the at least one memory 104 may be a computer-readable storage medium and may store instructions or programs. The instructions or programs may cause, when executed, the at least one processor operably connected to the at least one memory to perform operations according to Embodiments or implementations of the disclosure, related to the following operations.

For example, the processor 102 may receive, through the transceiver 106, information related to an LBT beam that a BS has used to acquire a COT. The information related to the LBT beam may be included in a GC-PDCCH.

The processor 102 may determine whether COT sharing is available based on the information related to the LBT beam. The processor 102 may perform LBT using Cat-1 LBT, Cat-2 LBT, Cat-3 LBT, or Cat-4 LBT according to whether the COT sharing is available. When determining that a channel corresponding to the performed LBT is idle, the processor 102 may transmit a UL channel through the transceiver 106.

A detailed method of performing the operation of the processor 102 may be based on [Method #1].

In another example, the processor 102 may transmit, through the transceiver 106, information related to an LBT beam that the UE has used to acquire a COT. The information related to the LBT beam may be included in CG-UCI.

A detailed method of performing the operation of the processor 102 may be based on [Method #2].

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the disclosure, the wireless device may be a communication modem/circuit/chip.

Specifically, instructions and/or operations, controlled by the processor 202 of the second wireless device 100 and stored in the memory 204 of the second wireless device 200, according to an Embodiment of the disclosure will be described.

Although the following operations will be described based on a control operation of the processor 202 in terms of the processor 202, software code for performing such an operation may be stored in the memory 204. For example, in the disclosure, the at least one memory 204 may be a computer-readable storage medium and may store instructions or programs. The instructions or programs may cause, when executed, the at least one processor operably connected to the at least one memory to perform operations according to Embodiments or implementations of the disclosure, related to the following operations.

For example, the processor 202 may receive, through the transceiver 206, information related to an LBT beam that a UE has used to acquire a COT. The information related to the LBT beam may be included in CG-UCI.

The processor 202 may determine whether COT sharing is available based on the information related to the LBT beam. The processor 202 may perform LBT using Cat-1 LBT, Cat-2 LBT, Cat-3 LBT, or Cat-4 LBT depending on whether the COT sharing is available, and when determining that a channel corresponding to the performed LBT is idle, transmit a DL channel through the transceiver 206.

A detailed method of performing the above-described operation of the processor 202 may be based on [Method #2].

In another example, the processor 202 may transmit, through the transceiver 206, information related to an LBT beam that the processor 202 has used to acquire a COT (S1801). The information related to the LBT beam may be included in a GC-PDCCH. Further, the processor 202 may receive a UL channel through the transceiver 206.

A detailed method of performing the above-described of the processor 202 may be based on [Method #1].

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

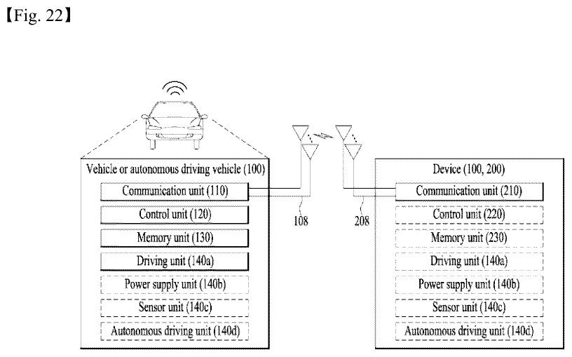

FIG. 22 illustrates a vehicle or an autonomous driving vehicle applied to the disclosure. The vehicle or autonomous driving vehicle may be implemented as a mobile robot, a car, a train, a manned/unmanned aerial vehicle (AV), a ship, or the like.

Referring to FIG. 22, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

The Embodiments of the disclosure described herein below are combinations of elements and features of the disclosure. The elements or features may be considered selective unless otherwise mentioned. Each element or feature may be practiced without being combined with other elements or features. Further, an Embodiment of the disclosure may be constructed by combining parts of the elements and/or features. Operation orders described in Embodiments of the disclosure may be rearranged. Some constructions of any an embodiment may be included in another Embodiment and may be replaced with corresponding constructions of another Embodiment. It will be obvious to those skilled in the art that claims that are not explicitly cited in each other in the appended claims may be presented in combination as an Embodiment of the disclosure or included as a new claim by a subsequent amendment after the application is filed.

In the disclosure, a specific operation described as performed by the BS may be performed by an upper node of the BS in some cases. Namely, it is apparent that, in a network comprised of a plurality of network nodes including a BS, various operations performed for communication with an MS may be performed by the BS, or network nodes other than the BS. The term ‘BS’ may be replaced with the term ‘fixed station’, ‘Node B’, ‘enhanced Node B (eNode B or eNB)’, ‘access point’, etc.

Those skilled in the art will appreciate that the disclosure may be carried out in other specific ways than those set forth herein without departing from the spirit and essential characteristics of the disclosure. The above Embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

While the above-described method and apparatus for transmitting and receiving a signal in an unlicensed band has been described with reference to an example in which they are applied to a 5G NewRAT system, they are also applicable to various wireless communication systems other than the 5G NewRAT system.

1. A method of performing an uplink (UL) transmission by a user equipment (UE) in a wireless communication system, the method comprising:
receiving information related to a sensing beam used by a base station (BS) to initiate a channel occupancy time (COT);
determining whether COT sharing of the COT is available based on a quasi co-location (QCL) relationship between the sensing beam and the UL transmission;
based on the COT sharing being not available, sensing a channel corresponding to the UL transmission based on a Type 1 channel access procedure (CAP), and based on the channel being sensed as idle, performing the UL transmission; and
based on the COT sharing being available, sensing the channel based on a Type 2 CAP, and based on the channel being sensed as idle, performing the UL transmission within the COT.

2. The method of claim 1, wherein it is determined that the COT sharing is available, based on a reference signal (RS) related to the sensing beam is in the QCL relationship with an RS related to the UL transmission.

3. The method of claim 1, wherein the information related to the sensing beam includes at least one of a synchronization signal block (SSB) index, a channel state information-reference signal (CSI-RS) index, or a sounding resource indicator (SRI).

4. The method of claim 1, wherein the information related to the sensing beam is included in a group common-physical downlink control channel (GC-PDCCH).

5. The method of claim 1, wherein the Type 1 CAP is performed based on backoff, and the Type 2 CAP is performed without backoff.

6. The method of claim 1, further comprising receiving information indicating to perform the Type 1 CAP before the UL transmission,
wherein based on the COT sharing being not available, the Type 1 CAP is performed based on the information indicating to perform the Type 1 CAP, and
wherein based on the COT sharing being available, the information indicating to perform the Type 1 CAP is ignored, and the Type 2 CAP is performed.

7. The method of claim 1, wherein it is determined whether the COT sharing is available by further considering that time resources and frequency resources of the UL transmission are included in time resources and frequency resources of a downlink (DL) transmission performed in the COT.

8. A user equipment (UE) for performing an uplink (UL) transmission in a wireless communication system, the UE comprising:
at least one transceiver;
at least one processor; and
at least one memory operably coupled to the at least one processor, and storing instructions which when executed, cause the at least one processor to perform operations,
wherein the operations include:
receiving information related to a sensing beam used by a base station (BS) to initiate a channel occupancy time (COT), through the at least one transceiver;
determining whether COT sharing of the COT is available based on a quasi co-location (QCL) relationship between the sensing beam and the UL transmission;
based on the COT sharing being not available, sensing a channel corresponding to the UL transmission based on a Type 1 channel access procedure (CAP), and based on the channel being sensed as idle, performing the UL transmission through the at least one transceiver; and
based on the COT sharing being available, sensing the channel based on a Type 2 CAP, and based on the channel being sensed as idle, performing the UL transmission within the COT through the at least one transceiver.

9. The UE of claim 8, wherein it is determined that the COT sharing is available, based on a reference signal (RS) related to the sensing beam is in the QCL relationship with an RS related to the UL transmission.

10. The UE of claim 8, wherein the information related to the sensing beam includes at least one of a synchronization signal block (SSB) index, a channel state information-reference signal (CSI-RS) index, or a sounding resource indicator (SRI).

11. The UE of claim 8, wherein the information related to the sensing beam is included in a group common-physical downlink control channel (GC-PDCCH).

12. The UE of claim 8, wherein the Type 1 CAP is performed based on backoff, and the Type 2 CAP is performed without backoff.

13. The UE of claim 8, wherein the operations further include receiving information indicating to perform the Type 1 CAP before the UL transmission, through the at least one transceiver,
wherein based on the COT sharing being not available, the Type 1 CAP is performed based on the information indicating to perform the Type 1 CAP, and
wherein based on the COT sharing being available, the information indicating to perform the Type 1 CAP is ignored, and the Type 2 CAP is performed.

14. The UE of claim 8, wherein it is determined whether the COT sharing is available by further considering that time resources and frequency resources of the UL transmission are included in time resources and frequency resources of a downlink (DL) transmission performed in the COT.

15. (canceled)

16. A method of performing a downlink (DL) transmission by a base station (BS) in a wireless communication system, the method comprising:
receiving information related to a sensing beam used by a user equipment (UE) to initiate a channel occupancy time (COT);
determining whether COT sharing of the COT is available based on a quasi co-location (QCL) relationship between the sensing beam and the DL transmission;
based on the COT sharing being not available, sensing a channel corresponding to the DL transmission based on a Type 1 channel access procedure (CAP), and based on the channel being sensed as idle, performing the DL transmission; and
based on the COT sharing being available, sensing the channel based on a Type 2 CAP, and based on the channel being sensed as idle, performing the DL transmission within the COT.

17-18. (canceled)
